(19) United States
(12) Patent Application Publication
(10) Pub. No.: US 2008/0201553 A1
(43) Pub. Date: Aug. 21, 2008

(54) NON-VOLATILE MEMORY SYSTEM

(75) Inventors: Kazuya Kawamoto, Sagamihara-shi (JP); Hiroshi Sukegawa, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/034,306

(22) Filed: Feb. 20, 2008

(30) Foreign Application Priority Data
Feb. 21, 2007 (JP) 2007-040408

(51) Int. Cl. G06F 12/10

(52) U.S. Cl. 711/206; 711/E12.059

(57) ABSTRACT

This non-volatile memory system includes: a non-volatile memory; and a memory controller controlling read and write of the non-volatile memory. Access control of the non-volatile memory system is performed in accordance with a logical address, using an address translation table within the memory controller that is updated in association with data write and that indicates a correlation between logical addresses provided by a host and physical addresses of the non-volatile memory. The non-volatile memory system is also configured to be able to set a system configuration and function in relation to the host.

### CROSS REFERENCE TO RELATED APPLICATIONS

This application is based on and claims the benefit of priority from prior Japanese Patent Application No. 2007-40408, filed on Feb. 21, 2007, the entire contents of which are incorporated herein by reference.

### BACKGROUND OF THE INVENTION

1. Field of the Invention

The present invention relates to a non-volatile memory system configured by electrically rewritable non-volatile memory cells, and particularly, to a memory system suitable for use in memory cards.

2. Description of the Related Art

NAND-type flash memory is known as one of electrically rewritable non-volatile semiconductor memory (EEPROM). The NAND-type flash memory has a smaller unit cell area than that of NOR-type and is easy to provide larger capacity. In addition, although the NAND-type flash memory has a slower read/write speed per cell than that of NOR-type, it may achieve substantially high-speed read/write operations, providing a larger cell range (physical page length) for read/write performed concurrently between a cell array and a page buffer.

By means of these features, the NAND-type flash memory is used as various storage media, including memory cards for use in digital cameras, etc. There has been a shift in capacity generation of such memory cards for digital cameras, from one with capacity in Megabytes where only a memory chip that stores two-value data is provided to the next in Gigabytes where a memory chip that stores multi-value data and a memory controller are provided.

In the NAND-type flash memory, a unit of data erase is a block that is defined as a set of NAND cell units (NAND strings) arranged in the direction of word lines. In conventional memory cards, a host controls read/write/erase operations in memory based on physical addresses using a logical/physical address translation table (see, for example, Japanese Patent Laid-Open No. 2006-195565).

### SUMMARY OF THE INVENTION

A non-volatile memory system according to one aspect of the present invention comprises: a non-volatile memory; and a memory controller controlling read and write of the non-volatile memory, wherein access control of the non-volatile memory system is performed in accordance with a logical address, using an address translation table within the memory controller updated in association with data write and indicating a correlation between logical addresses provided by a host and physical addresses of the non-volatile memory, and wherein the non-volatile memory system is configured to be able to set a system configuration and function in relation to the host.

### BRIEF DESCRIPTION OF THE DRAWINGS

FIG. 1 illustrates a flash memory system (a memory card) according to an embodiment of the invention;

FIG. 2 illustrates a configuration of functional blocks of the same memory card;

FIG. 3 illustrates a configuration of a memory cell array in the same memory card;

FIG. 4 illustrates an address translation table in a memory controller of the same memory card;

FIG. 5 illustrates a pin configuration of the same memory card;

FIG. 6 illustrates functions and applied protocols of the same memory card;

FIG. 7 illustrates command input cycles of the same memory card;

FIG. 8 illustrates address input cycles of the same memory card;

FIG. 9 illustrates data input cycles of the same memory card;

FIG. 10 illustrates a data output cycle of the same memory card;

FIG. 11 illustrates functions and command layers of the same memory card;

FIG. 12A illustrates a power-on sequence in the same memory card;

FIG. 12B illustrates a timing waveform of the power-on sequence in the same memory card;

FIG. 13 illustrates a timing waveform of ID read in the same memory card;

FIG. 14 illustrates ID data of the same memory card;

FIG. 15 illustrates content of a card configuration;

FIG. 16 illustrates states of function service setting;

FIG. 17 illustrates data states of sector count;

FIG. 18 illustrates a timing waveform of sector address;

FIG. 19 illustrates details of address cycles;

FIG. 20 illustrates an address shifting function;

FIG. 21 illustrates a procedure of read sectors in the same memory card;

FIG. 22 illustrates a mode setting for the same read sectors;

FIG. 23 illustrates ECC and CRC16 functions in read sectors;

FIG. 24 illustrates a data format in the cases of transfer data size 512/528 Bytes;

FIG. 25 illustrates a data format in the cases of transfer data size 2048/2112 Bytes;

FIG. 26 illustrates a data format in the cases of transfer data size 4096/4224 Bytes;

FIG. 27 illustrates a data format of an extra 16-Byte region (in the case of ECC);

FIG. 28 illustrates a data format of another extra 16-Byte region (in the case of CRC16);

FIG. 29 is a diagram for illustrating a relation between a read sectors and a status read;

FIG, 30 is a diagram for illustrating a relation between a read sectors and a buffer R/W;

FIG. 31 illustrates a timing wave form of read sectors;

FIG. 32 illustrates a procedure of write sectors in the same memory card;

FIG. 33 illustrates a mode setting for write sectors in the same memory card;

FIG. 34 illustrates ECC and CRC16 functions in write sectors;

FIG. 35 illustrates a data format in the cases of transfer data size 512/528 Bytes;

FIG. 36 illustrates a data format in the cases of transfer data size 2048/2112 Bytes;

FIG. 37 illustrates a data format in the cases of transfer data size 4096/4224 Bytes;

FIG. 38 illustrates a data format of an extra 16-Byte region (in the case of ECC);

FIG. 39 illustrates a data format of another extra 16-Byte region (in the case of CRC16);

FIG. 40 illustrates a timing waveform of write sectors;

FIG. 41 illustrates a timing wave form of write sectors with error check of transfer data;

FIG. 42 illustrates states of status data obtained from the status read;

FIG. 43 illustrates a relation between an ECC function and a status bit;

FIG. 44 illustrates a timing waveform of status read;

FIG. 45 illustrates a data format of CIS;

FIG. 46 illustrates a timing waveform of buffer read/write;

FIG. 47 illustrates a timing waveform of reset command;

FIG. 48 illustrates a timing waveform of power down;

FIG. 49 illustrates a timing waveform of auto block erase;

FIG. 50 illustrates a timing waveform for resetting sector addresses and sector counts;

FIG. 51 illustrates a timing waveform of pass through mode setting;

FIG. 52 is a timing diagram of read sectors associated with status information read;

FIG. 53 illustrates a case of skipping input of a dummy sector address in the same read sectors;

FIG. 54 is a timing diagram of write sectors associated with status information read; and

FIG. 55 illustrates a case of skipping input of a dummy sector address in the same write sectors.

### DETAILED DESCRIPTION OF THE EMBODIMENTS

An embodiment of the present invention will now be described below with reference to the accompanying drawings.

### 1. System Overview

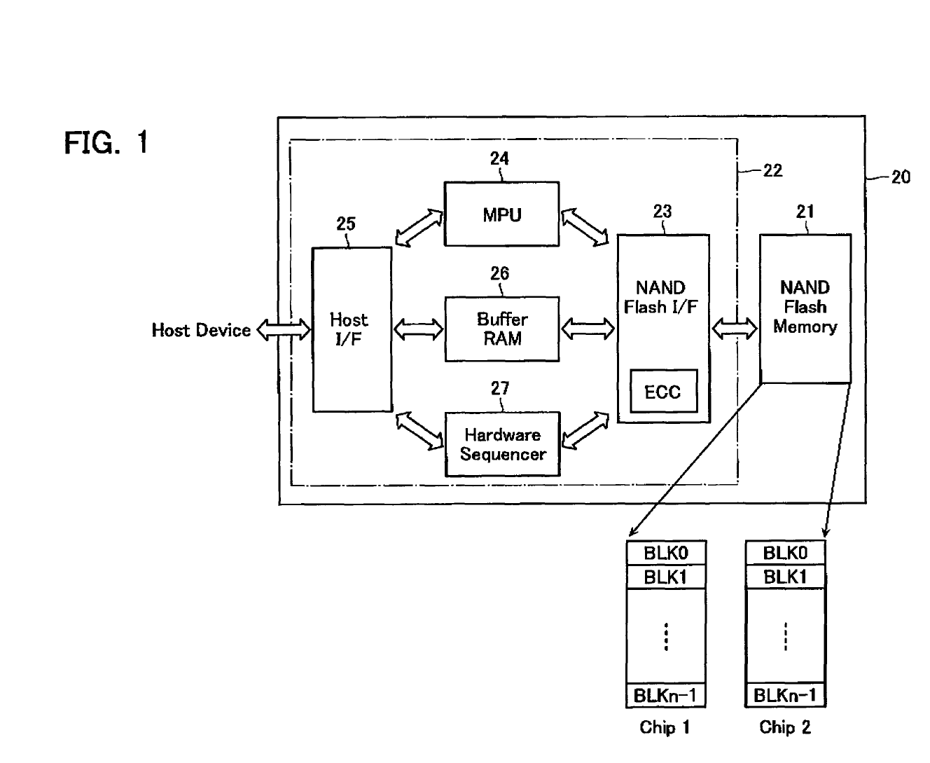

FIG. 1 illustrates a configuration of a memory card 20, which represents a non-volatile memory system according to an embodiment of the invention. The memory card 20 configures modules with a memory controller 22 that controls a NAND-type flash memory chip 21 and its read/write operations.

The flash memory chip 21 may be a plurality of memory chips. Although FIG. 1 illustrates two memory chips, i.e., chip 1 and chip 2, these are also controlled by the single memory controller 22.

The memory controller 22 is a one-chip controller that has a NAND flash interface 23 for transferring data to and from the memory chip 21, a host interface 25 for transferring data to and from a host device, a buffer RAM 26 for temporarily storing read/write data, etc., an MPU 24 for controlling, not only data transfer, but also entire operations in the memory card, a hardware sequencer 27 for use in, e.g., sequence control of read/write of firmware (FW) within the NAND-type flash memory 21, and user data transferred by the host system.

When the memory card is powered on, an initializing operation (power-on initial setup operation) is performed to automatically read firmware (control program) stored in the flash memory 21, which is in turn transferred to the data register (buffer RAM) 26. This read control operation is performed by the hardware sequencer 27.

Using the firmware loaded on the buffer RAM 26, the MPU 24 creates tables on the RAM 26, accesses the flash memory 21 in response to commands from the host, controls data transfer, and so on.

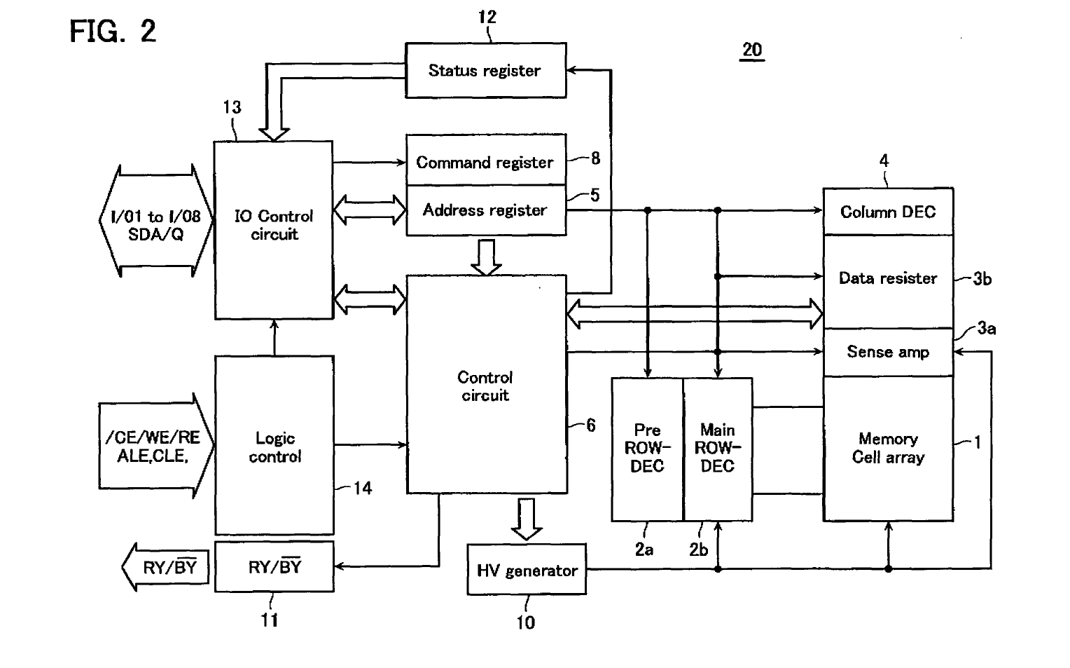

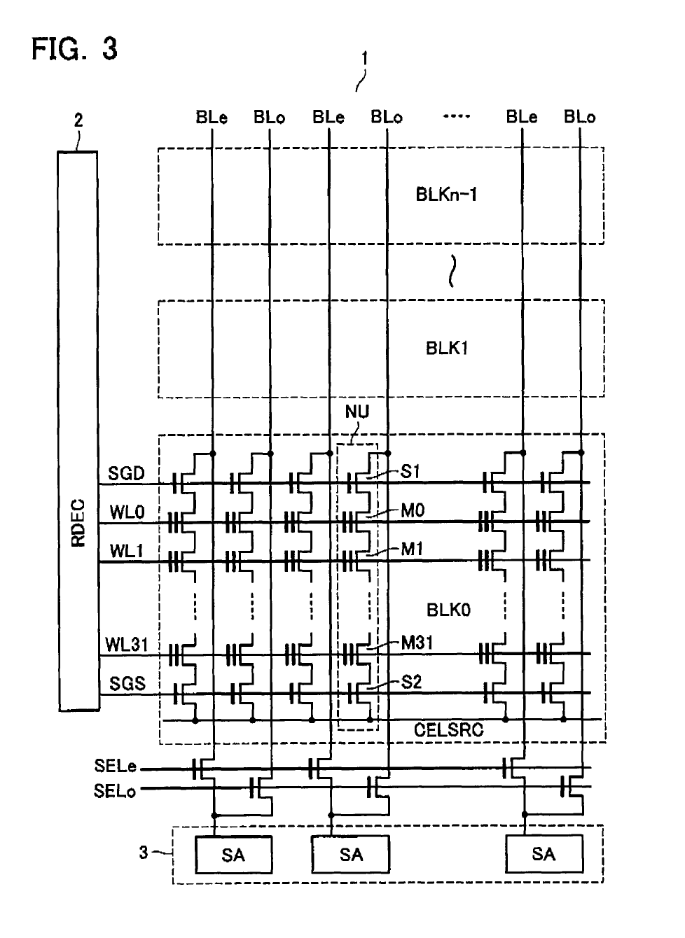

However, it is not essential for the present memory system that the memory chip 21 and the controller chip 22 are separate chips. FIG. 2 illustrates a configuration of functional blocks where a logic control is described in an integrated manner for the memory chip 21 and the controller 22 of the memory card 20 of FIG. 1. In addition, FIG. 3 illustrates a configuration of a cell array in the memory core portion.

As illustrated in FIG. 3, a memory cell array 1 includes NAND cell units (NAND strings) NU arranged therein that have a plurality of electrically rewritable non-volatile memory cells (in FIG. 3, 32 memory cells) M0-M31 connected in series.

One end of each of the NAND cell units NU is connected via a selection gate transistor S1 to a respective bit line BLo and BLe, and the other end connected via a selection gate transistor S2 to a common source line CELSRC. Control gates of the memory cells M0-M31 are connected to respective word lines WL0-WL31. The gates of the selection gate transistors S1, S2 are connected to respective selection-gate lines SGD, SGS.

A set of NAND cell units arranged in the direction of word lines configures a block (erase block) that represents the minimum unit of data erase. As illustrated, a plurality of blocks BLK0-BLKn-1 are arranged in the direction of bit lines.

A sense amplifier circuit 3, which is utilized to read and write cell data, is positioned at one end of each of the bit lines BLe, BLo, and a row decoder 2, which selectively drives each word line and selection-gate line, is positioned at one end of each of the word lines. FIG. 3 describes the case where even-numbered bit lines BLe and their adjacent odd-numbered bit lines BLo are selectively connected by a bit-line selection circuit to a respective sense amplifier SA of the sense amplifier circuit 3.

Commands, addresses and data are input via an input control circuit 13. External control signals, such as chip-enable signals/CE, write-enable signals/WE, or read-enable signals/RE, are input to a logic circuit 14 for timing control. Commands are decoded at a command register 8.

A control circuit 6 controls data transfer and performs write/erase/read sequence control. A status register 11 outputs Ready/Busy states of the memory card 20 to a Ready/Busy terminal. In addition to this, a status register 12 is also provided that informs the host of the states of the memory 20 (Pass/Fail, Ready/Busy, etc.) via an I/O port.

Addresses are transferred via an address register 5 to the row decoder 2 (including a pre row decoder 2a and a main row decoder 2b) or a column decoder 4. Write data is loaded via an I/O control circuit 7 through the control circuit 6 to the sense amplifier circuit 3 (including a sense amplifier 3a and a data register 3b), while read data is output via the control circuit 6 and the I/O control circuit 7 to the outside.

A high-voltage generation circuit 10 is provided for producing a high voltage necessary for each mode of operation. The high-voltage generation circuit 10 produces a predetermined high voltage based on orders from the control circuit 6.

In a conventional “xD-Picture card™” (hereinbelow, simply referred to as a “xDP™ card”), addresses of the flash memory of the card are managed by a host using a correlational table (a logical/physical address translation table) between physical addresses and logical addresses of the flash memory for both cases: when a two-value NAND flash memory on the level of 512 MB (herein, referred to as a “G1 card” or “G1 mode”) is used, and when, in emulation of the G1 card, a multi-value NAND flash memory on the level of 1 to 2 GB (herein, referred to as a “G2 card” or “G2 mode”) is used. This is referred to as a Physical Block Access (PBA) scheme.

Besides, the size of each erase block for the NAND flash memory used in the G1 card is, e.g., 16 kB, while the size of each erase block for the NAND flash memory used in the G2 card is, e.g., 256 kB. As such, the size of each erase block for the NAND flash memory to be mounted is larger in the G2 card than in the G1 card. The G2 card is provided with a controller therein, which controls the NAND flash memory upon request. Specifically, the controller in the G2 card translates an address with an assumed smaller size of each erase block to the actual address of the NAND flash memory with a larger size of an erase block. With this address translation, the G2 card retains compatibility with the G1 card when it is accessed by a host under the assumption that the host accesses the G1 card.

In contrast, although a multi-value NAND flash memory with over 2 GB of capacity is used, this embodiment has the same shape or pin configuration of the NAND flash memory as that of the G2 card and uses a Logical Block Access (LBA) scheme, instead of a PBA scheme up to the G2 card. That is, the logical/physical address translation table is held by the memory controller on the card side and the host accesses the flash memory only on the basis of logical addresses thereof without managing physical addresses. Hereinbelow, the memory card so configured is referred to as a “G3 card” or “G3 mode”.

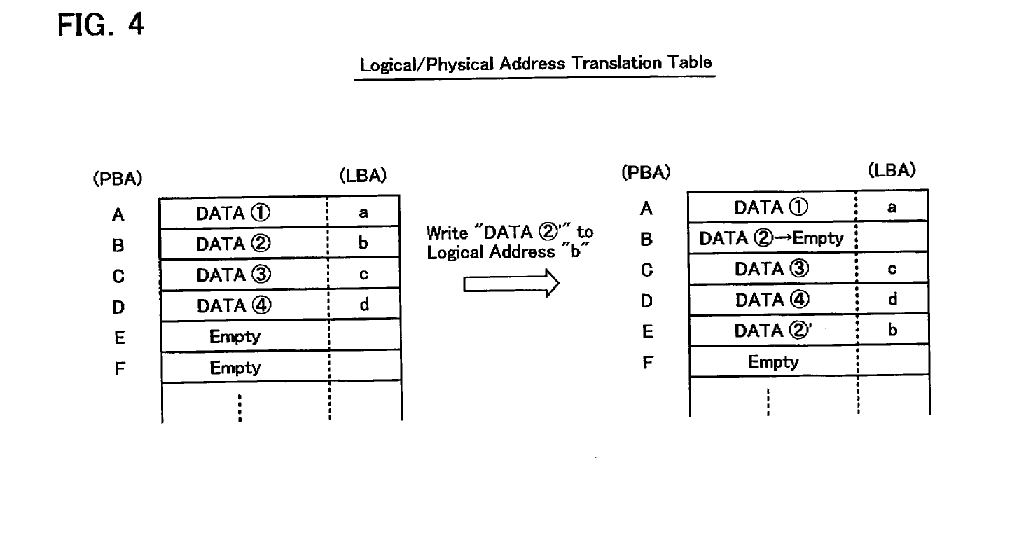

FIG. 4 illustrates the logical/physical address translation table on the card side. With reference to FIG. 4, an address management method of the LBA scheme will be specifically described below. A typical translation table is illustrated on the left side of FIG. 4 where DATA1), 2), 3), 4), each of which represents respective data of logical block addresses (LBA) a, b, c, d, are stored in respective physical block addresses (PBA) A, B, C, D.

Based on this state, consider that new data DATA2)′ is written to the logical address b as follows:

The host merely transmits the logical address b and the data DATA2)′ without regard to the fact that the data of the logical address b has been written to PBA=B. At this moment, on the card side, an empty block is automatically searched for and the data DATA2)′ is written to, e.g., a physical address PBA=E as data of a logical address LBA=b. Then, the original data of LBA=b may be erased.

In this way, the logical/physical translation table on the card side is updated for each write operation. Thereafter, access control of read/write is performed based on the updated table.

It is important to the system of the memory card 20 of this embodiment that functions and configurations may be selected in a flexible manner depending on the host device. The system overview of the G3 card of this embodiment is as follows:

(1) The card can decide the mode of operation on its own, as it knows the type of the host. In addition, the host can selectively set the card configuration and functions (card capacity, use/no use of extra 16 Bytes, use/no use of an ECC function, a function service & sector count, etc.).

(2) The interface protocol to be used is the same as a normal xDP™ card.

(3) The memory chip to be mounted is a multi-value NAND flash memory based on, e.g., a 56-nm rule.

(4) The access scheme is a LBA scheme as mentioned earlier. Theoretically, the card capacity may be enhanced to 4 GB-2 TB on an I/F definition basis, although it depends on the memory chips to be mounted.

(5) One sector (e.g., 512 MB) is considered as the minimum unit of data transfer. Then, resulting from the selection of function, a size of the unit of data transfer (the range of one continuous access) may be specified for read/write by inputting a sector count and a logical sector address (an initial value) in one command sequence. If such selection of function is not performed, such an access mode is provided where the range of access in one-command sequence is limited to one sector.

(6) Since a sector multiplexing is used, the size of the unit of data transfer may be changed between 528 Bytes-4224 Bytes.

### 2. Interface

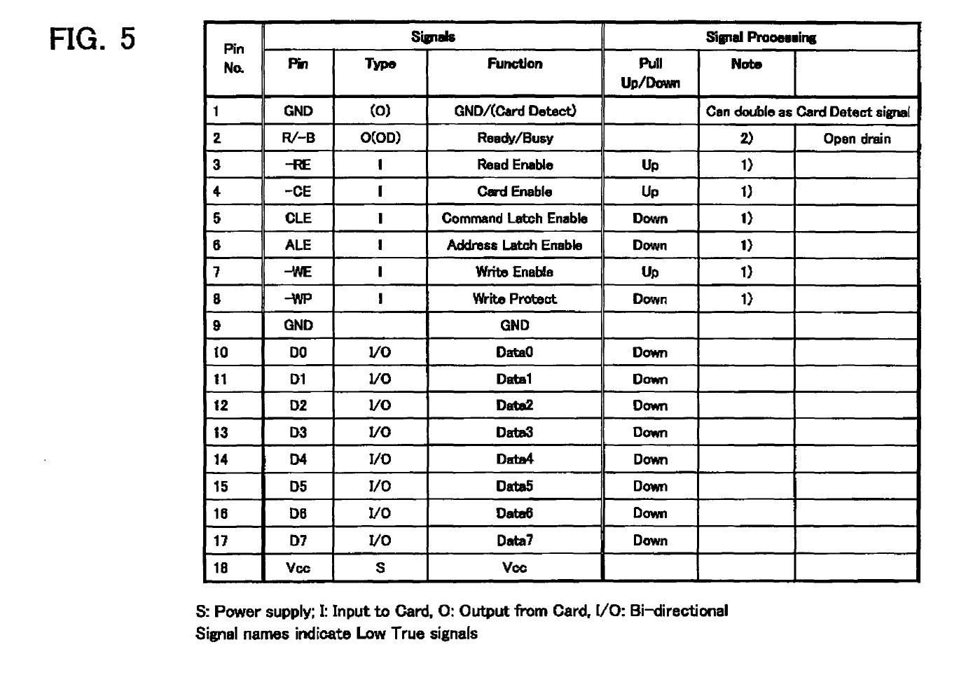

FIG. 5 illustrates the number, name and functions of pins assigned to the memory card, which are the same as those of the current xDP™ card, as described above.

The input buffer is of Schmitt trigger type. The Ready/Busy in the pin number 2 is pulled up at the host side to Vcc with a resistance between 10 k-100 kΩ.

### 3. Memory Card Functions

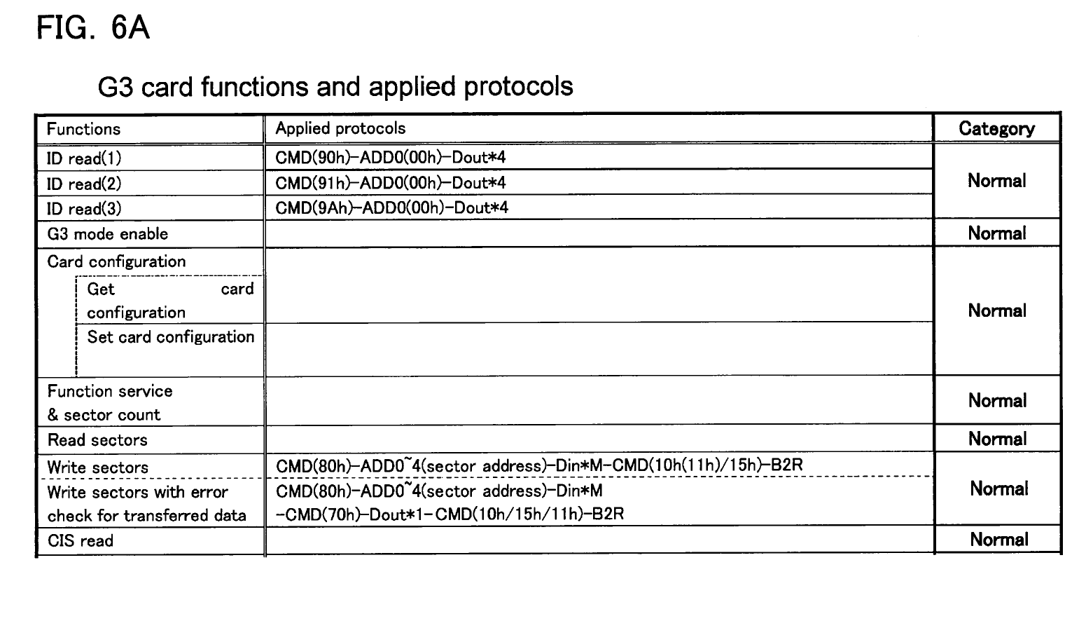

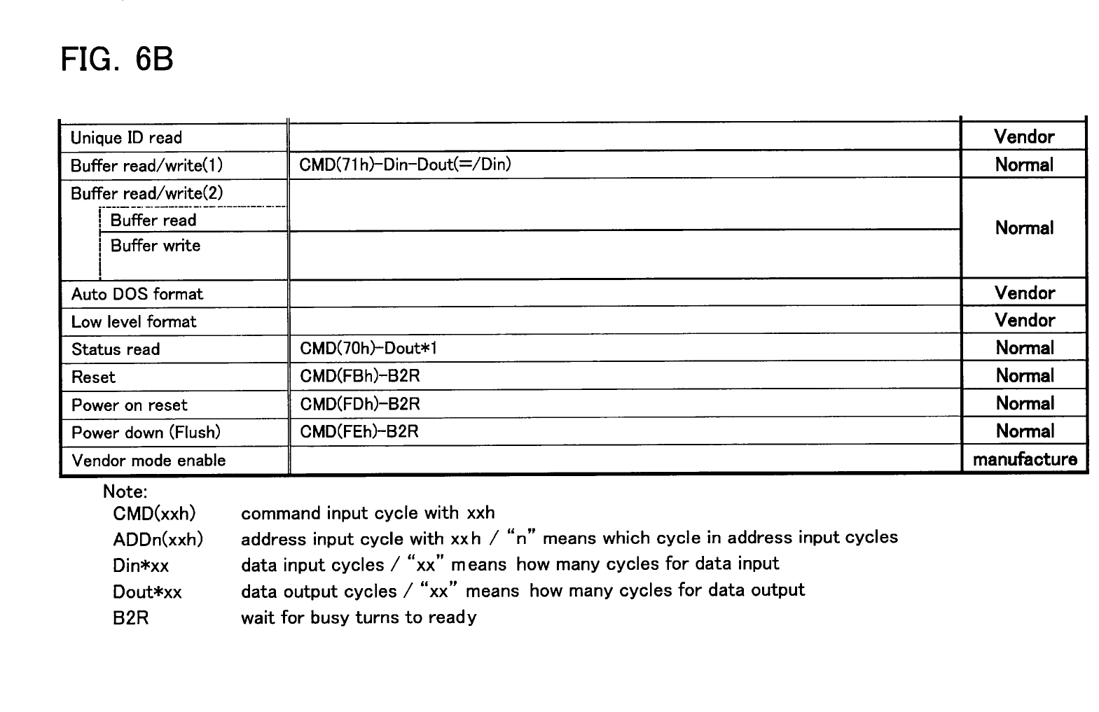

FIG. 6 illustrates memory card functions and the applied protocols.

Wherein, “CMD (xxh)” means a command input cycle with xxh. Here, “h” means hexadecimal notation. Indeed, 8-bit signals are provided in parallel to 8-bit I/O pins (D0-D7). “ADDn(xxh)” means an address input cycle with xxh and “h” means which cycle in address input cycles. “Din*xx” means a data input cycle and “xx” means how many cycles for data input. “Dout*xx” means a data output cycle and “xx” means how many cycles for data output. “B2R” means wait for busy turns to ready.

As illustrated in FIG. 6, various card functions are defined, i.e., an “ID read” command that is a function for reading ID data, a “G3 mode enable” command that is a function for setting the G3 mode to valid, a “card configuration” command that is a function for obtaining or setting the specific data configuration or capacity of the G3 card, and so on. Each of these functions will be later described in detail.

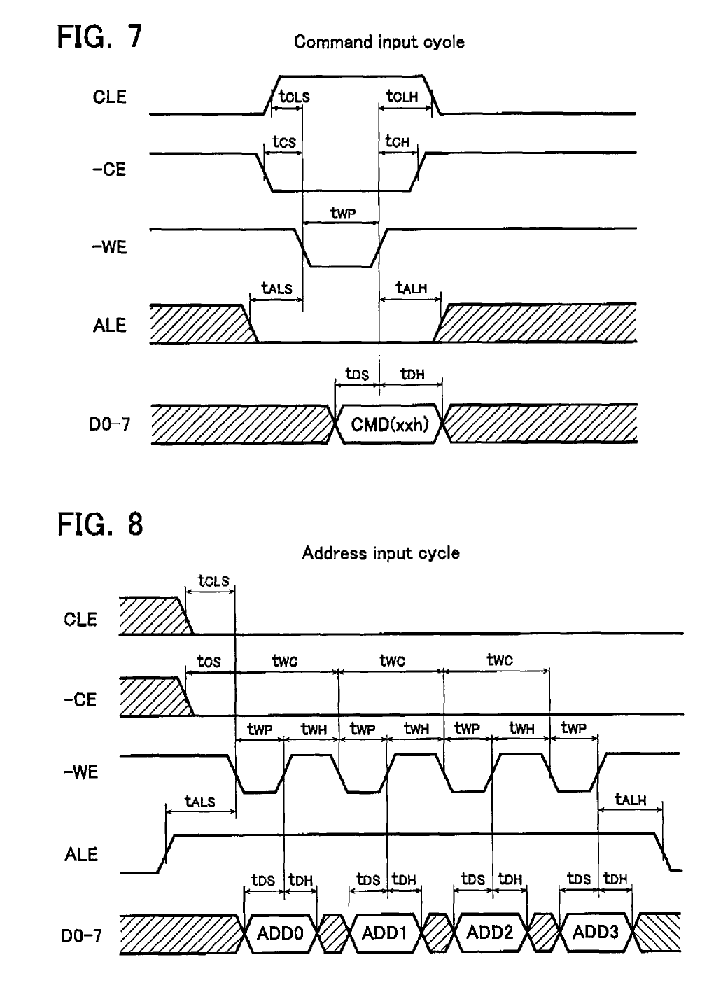

FIG. 7 illustrates command input cycles. Upon input of a command “CMD(xxh)” in synchronization with a write enable/WE during a command latch enable CLE retained in “H”, the command “CMD(xxh)” is latched when the /WE transitions to “H”.

FIG. B illustrates address input cycles. Upon input of an address in synchronization with the write enable/WE during an address latch enable ALE retained in “H”, the address is latched when the /WE transitions to “H”.

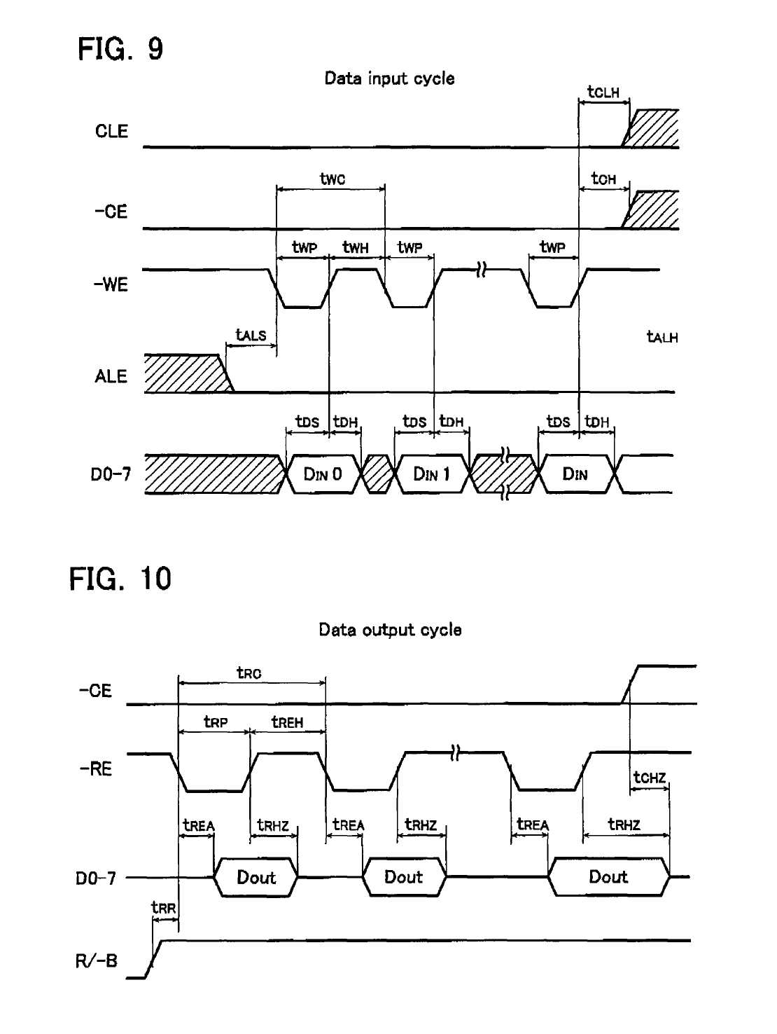

FIG. 9 illustrates data input cycles. Upon input of data Din in synchronization with a write enable/WE during CLE and ALE in “L”, the data Din is latched when the /WE transitions to “H”.

FIG. 10 illustrates data output cycles. Upon input of a read enable/RE, read data stored in the flash memory is output when the /RE transitions to the “L” level.

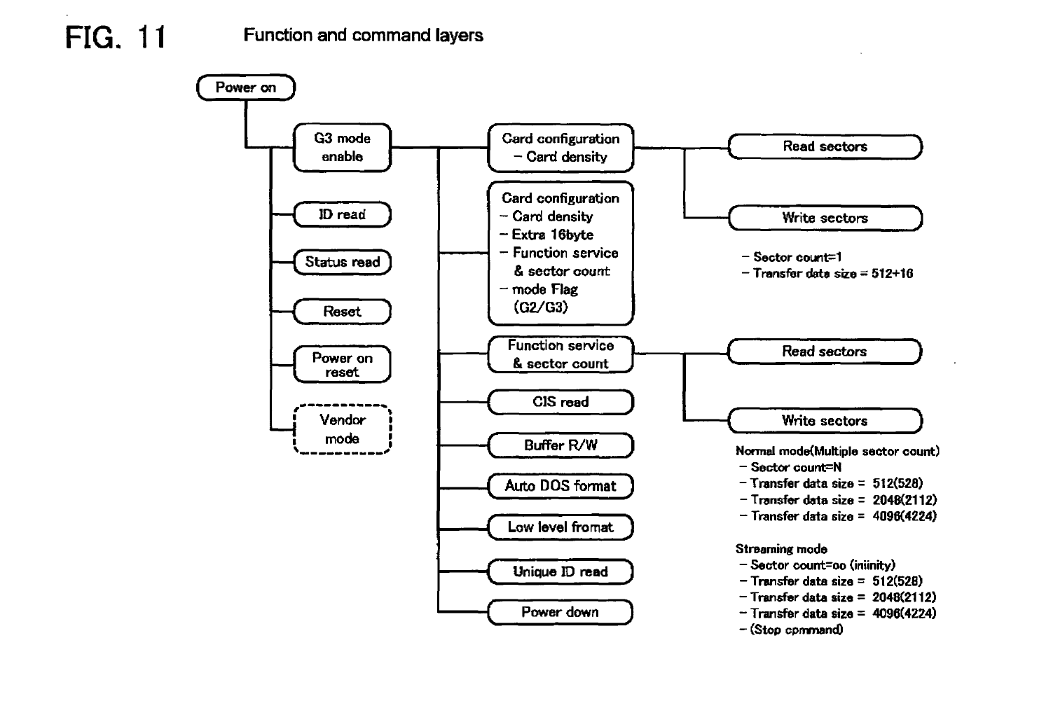

FIG. 11 illustrates functions and commands in three command layers.

Essential commands for operations of the G3 card includes: “G3 mode enable”, “ID read” and “Status read” in a first command layer; “card configuration-card density” in a second command layer; and “read sectors” and “write sectors” in a third command layer, respectively.

### 4. Power-On Sequence

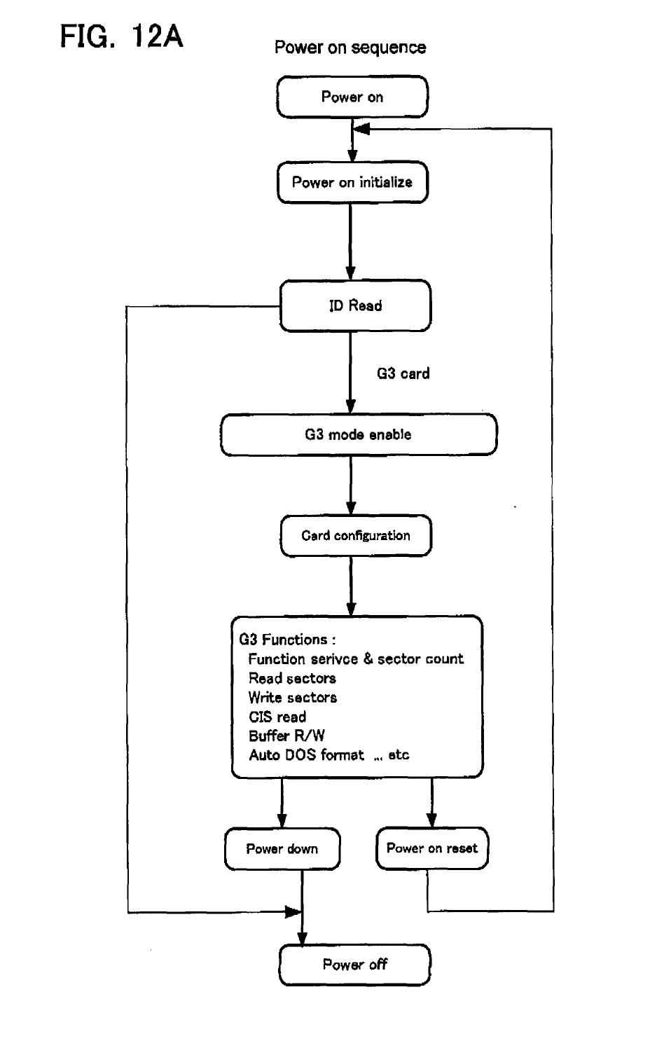

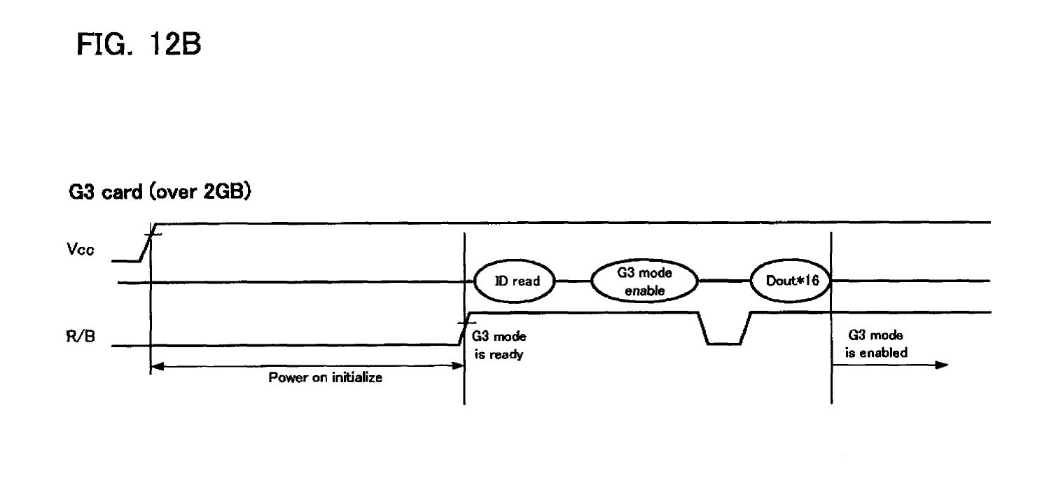

FIG. 12A illustrates a power-on sequence of the G3 card; and FIG. 12B illustrates the timing waveform associated therewith. In an initializing operation immediately after power-on, such firmware is automatically read to a register of the memory controller 22 that is necessary for read/write control of the flash memory 21 and retained in the flash memory 21.

For the G3 card as illustrated in FIG. 12B, after the initializing operation of power-on, the G3 card is brought into a ready state of G3 mode. At this moment, an “ID read” command is first executed to determine whether it is a G3 card and then a “G3 mode enable” command is input. Subsequently, after a predetermined busy period (R/B=“L”), checking data “Dout” is read so as to enable the G3 mode. If it is determined at the ID read that it is not a G3 card, then the power is turned off accordingly.

### 5. ID Data Read

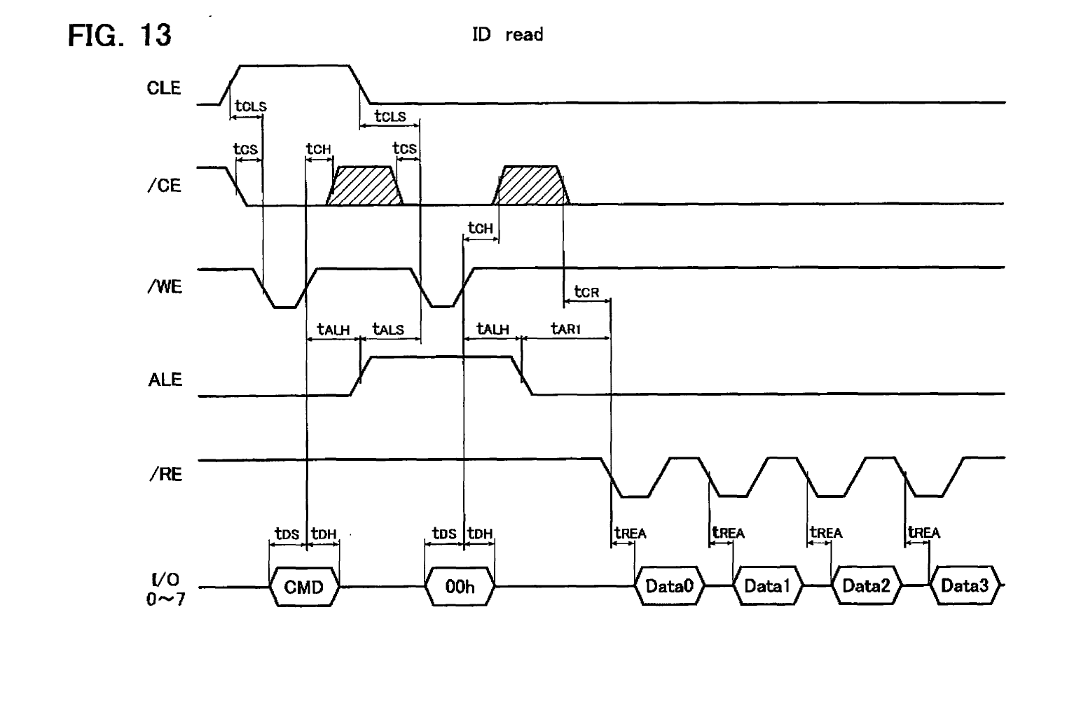

FIG. 13 is a timing diagram of ID data read. During CLE=“H”, a command CMD is input in synchronization with a write enable/WE. Then, during ALE=“H”, an address “00h” is input in synchronization with the write enable/WE. Thereafter, as the read enable/RE is toggled, ID data Data0, Data1, . . . , and so on are output for identifying the G2 card and the G3 card.

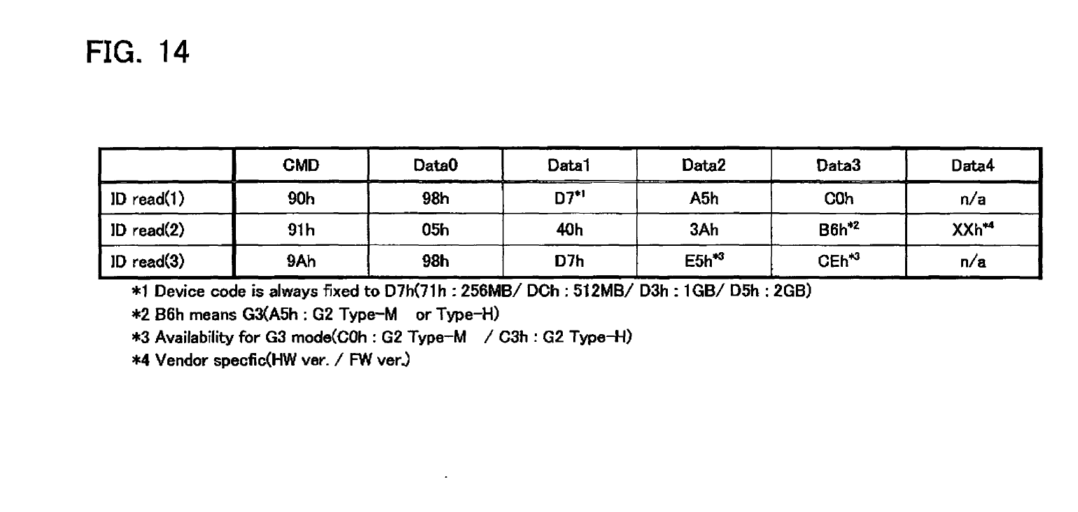

In addition to the commands, FIG. 14 also illustrates three modes of ID read: ID read(1) through ID read(3). The ID read(1) for a command <90h> is designed to always indicates the card capacity of 4 Gbytes as a device code (Data1). That is, the card capacity is not identified by the ID data. The actual card capacity is determined by the total number of sectors with 512 Bytes/sector in the “card configuration”, as discussed below.

### 6. G3 Mode Enable

The G3 card is configured so as to also be connected to a G2 card slot. Thus, the “G3 mode enable” command is provided for preventing any incorrect access by the host based on a G2 card protocol. The G3 card will not respond to the host until the “G3 mode enable” command is issued, except for ID data read, reset, and status read operations.

In the “G3 mode enable” command sequence, after the command is transmitted, the host needs to perform a read operation to determine whether the G3 mode has been set. Provided that data read is performed for 16 Bytes of data and when the last 2 Bytes are “AAh” and “55h”, it is determined that the G3 mode is enabled.

If the card has a capacity of less than 2 GB and supports a G2 mode and a G3 mode, then it is in a G2 mode immediately after power-on. In this case, it is also necessary to execute the “G3 mode enable” command in order to set the G3 mode.

### 7. Card Configuration

Prior to a start of the G3 card access, the host executes a “card configuration” command for setting the card configuration (including card capacity, use/no use of extra 16 Bytes, use/no use of an ECC function, a function service & sector count, etc.). The “card configuration” command has the following functions: (1) a “card configuration” obtaining function for obtaining card information including valid functions, and (2) a “card configuration” setup function for setting functions used by the host based on the obtained information.

In a “card configuration” obtaining command sequence, the host may know the total number of sectors with 512 Bytes/sector as well as the card capacity based on the obtained data D_{OUT} of 16 Bytes.

In a “card configuration” setup command sequence, the host uses Byte 5 out of 16 Bytes to determine the transfer data size of the G3 mode, etc. That is, the 16-Byte data D_{OUT} obtained at the above-mentioned “card configuration” obtaining command sequence is rewritten to 16-Byte data “Din” as needed, which is in turn transmitted to the card as setup data. In this way, the configuration and functions of the G3 card are selectively set in relation to the host.

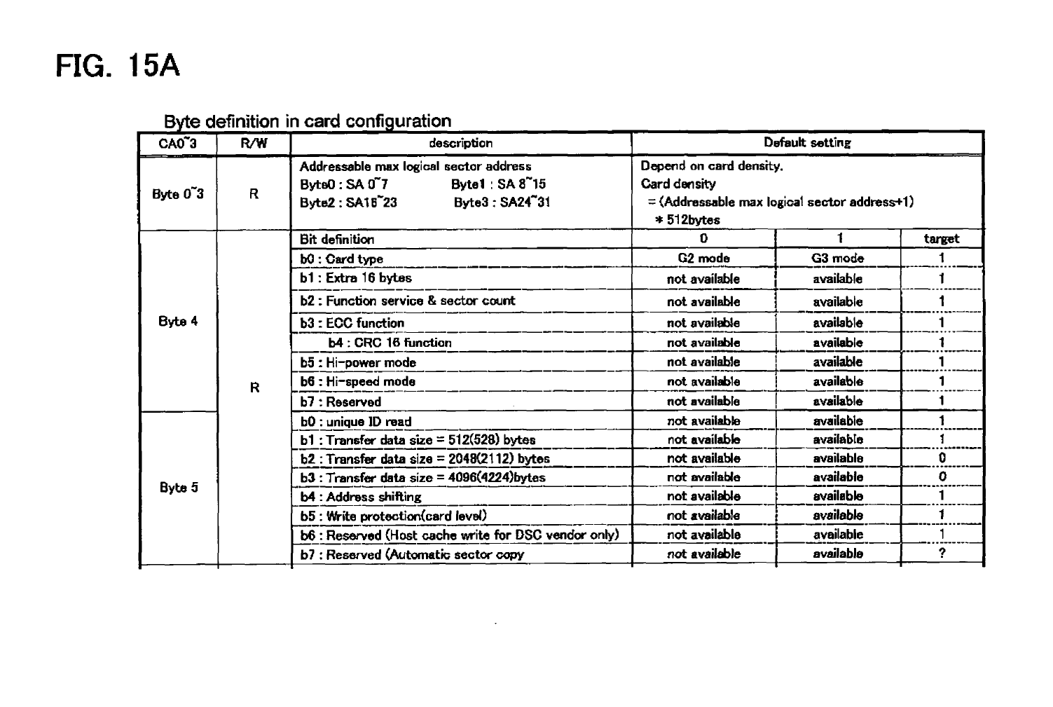

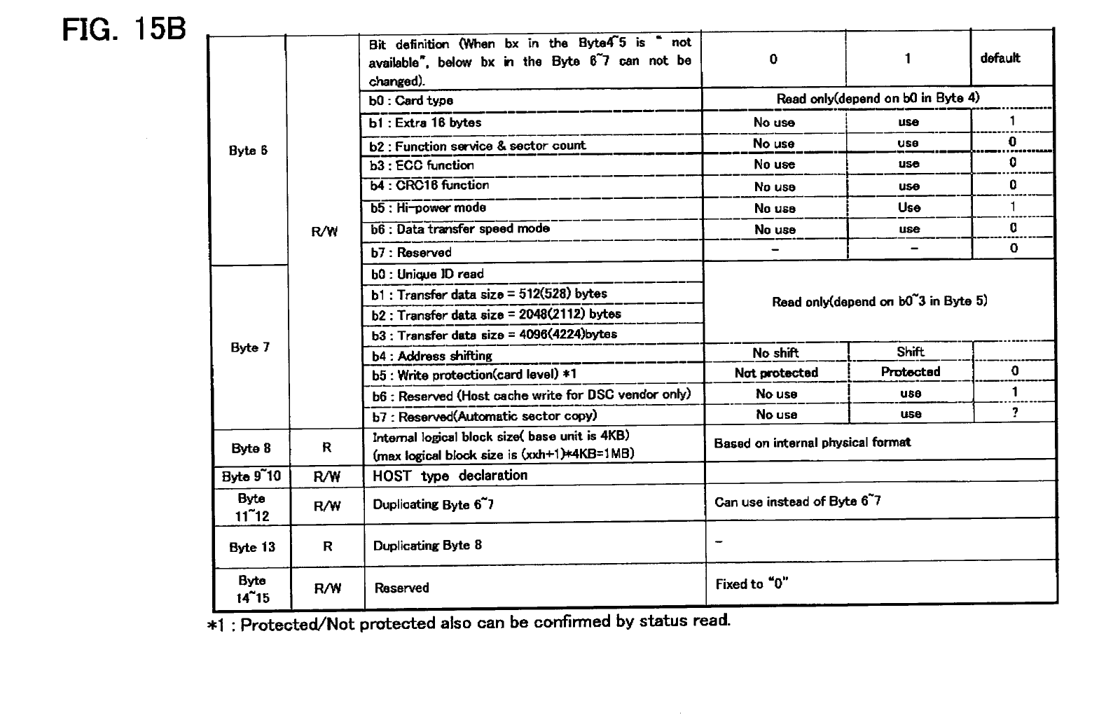

FIG. 15 illustrates content of the 16 Bytes in the “card configuration”. That is, the “card configuration” defines the internal configuration of the card, such as a configuration of transfer data in the G3 card, on/off of an ECC function or CRC16 function, or setting of a “function service & sector count” function.

The content of each Byte will now be specifically described below.

Byte 0-3 are the addressable max logical sector addresses, wherein Byte 0 represents sector addresses SA0-7, Byte 1 represents sector addresses SA8-15, Byte 2 represents sector addresses SA16-23, and Byte 3 represents sector addresses SA24-31.

The lowest bit “b0” of each Byte 4 and 6 indicates a card type, wherein b0=“0” represents the G2 mode and b0=“1” represents the G3 mode.

The bit “b1” of each Byte 4 and 6, which is only valid for the G3 mode, indicates use/no use of extra 16 bits. The bit “b1” needs to be turned on in order to validate the ECC function.

The bit “b2” of each Byte 4 and 6, which is only valid for the G3 mode, indicates a function service & sector count bit that validates various functions. If the bit “b2” is off, then the transfer data size is 512/528 Bytes and the sector count is always “1”. In addition, the ECC function and the cache write by the host are disabled.

The bit “b3” of each Byte 4 and 6, which is only valid for the G3 mode, indicates the ECC function using the above-mentioned extra 16-Byte region. When a write operation is performed, the ECC function is used to check for transfer data errors. The absence or presence of transfer errors can be known through the status read. When the following CRC16 is used, the transfer data check is based on CRC16.

The bit “b4” of each Byte 4 and 6, which is only valid for the G3 mode, indicates the CRC16 function using the above-mentioned extra 16-Byte region. When read and write operations are performed, the host uses a CRC16 code to check the transfer data. When writing, the absence or presence of transfer errors can be known through the status read and, if required, data may be retransmitted.

The bit “b5” of each Byte 4 and 6, which is only valid for the G3 mode, indicates a Hi-power mode. For example, achieving a high speed performance in sector write requires a large amount of power consumption. The maximum current consumption for the G3 card is, e.g., 120 mA. In a normal operating speed, for example, a normal-power mode with current consumption of not more than 40 mA is selected, which enables a Hi-power mode with large current consumption to be selected for high speed performance.

The bit “b6” of each Byte 4 and 6, which is only valid for the G3 mode, indicates a Hi-speed mode. That is, b6=“1” indicates that the host can access the G3 card in a 20 ns cycle, while b6=“0” indicates that a 30 ns or more access cycle is required.

The bit “b0” of each Byte 5 and 7 is a unique ID with 128 bits that is read by a special command.

The bits “b1”-“b3” of each Byte 5 and 7 indicate the transfer data size in the G3 mode. That is, b1=“1” indicates a transfer data size of 512/528 Bytes, b2=“1” indicates a transfer data size of 2048/2112 Bytes, and b3=“1” indicates a transfer data size of 4096/4224 Bytes.

Each transfer data size may be changed by executing a “function service & sector count” command.

The bit “b4” of each Byte 5 and 7 validates an “address shifting” function in the G3 mode. Using this function, a sector address may automatically be shifted during the G3 mode. When this function is used, the maximum of the card capacity is limited to 8 GB, as discussed in detail in a later section, “Sector Address”.

The bit “b5” of each Byte 5 and 7 validates a write protection function in the G3 mode. When this function is used, the sector write is prohibited, the status always becomes “Pass”, and only read sectors is permitted.

The bit “b6” of each Byte 5 and 7 validates a “host cache write” function in the G3 mode. The bit “b6” is set as the “function service & sector count” command is executed. Specifically, setting the bit “b6” enables transfer data to be temporality transferred to an internal cache block so as to minimize internal overhead.

The bit “b7” of each Byte 5 and 7 validates an “automatic sector copying” function in the G3 mode.

Byte 8 indicates the size of internal logical blocks in reading.

Byte 9-10 has a function for informing the host type (DSC or R/W) and the type of access pattern, based on which the card can determine an optimal method of operation. Based on this function, the G3 card may interact with the host in a flexible manner, i.e., an optimal method may be determined at the card side.

### 8. Function Service & Sector Count

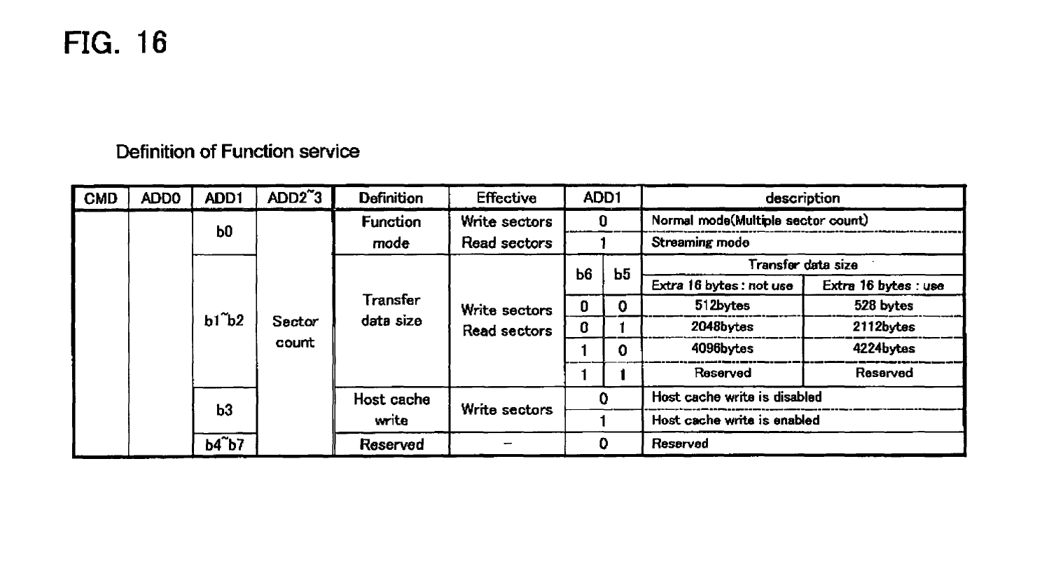

The “function service & sector count” command enables various function services to be validated. As illustrated in FIG. 16, the mode and the transfer data size are determined at a second cycle of the address, “ADD1”, following the command. For example, the transfer data size may be selected in a various way, such as 512 (or 528) Bytes, 2048 (or 2112) Bytes, 4096 (or 4224) Bytes, and so on.

Unless the command is used, the transfer data size is fixed to 512 (or 528) Bytes and the sector count becomes “1”.

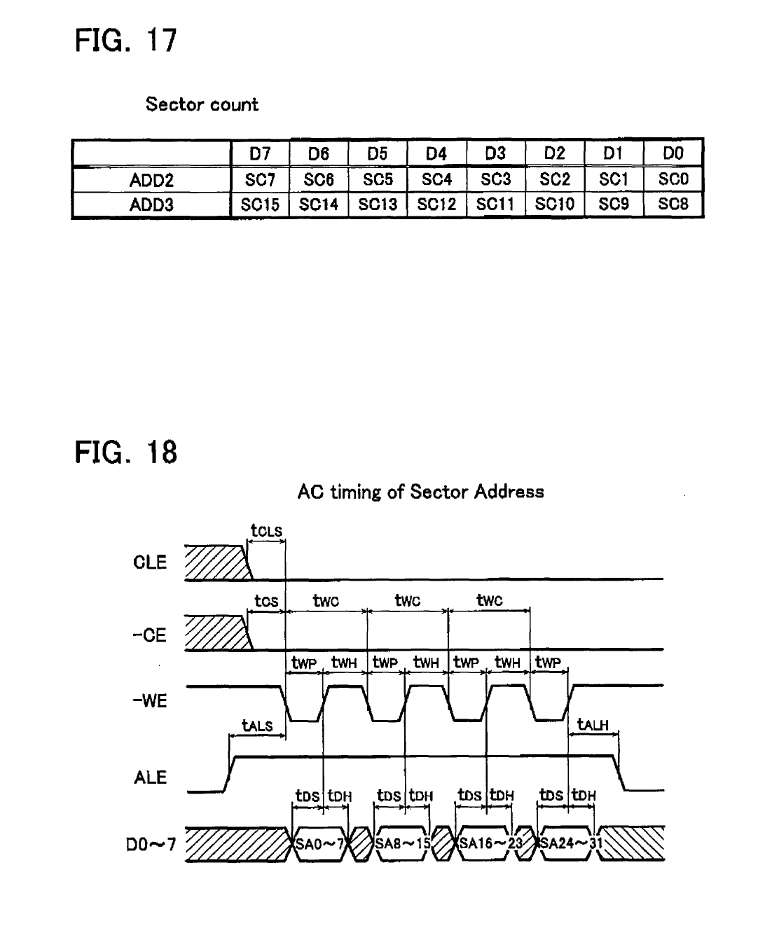

As illustrated in FIG. 17, the last two cycles “ADD2-3” are the sector count, which may be set based on ADD2 (8 Bytes) and ADD3 (8 Bytes). The sector count means the number of sectors that are included in a data unit to be transferred. The default value after power-on is “sector count=1”. Once it is set, the sector count is retained until any of the following satisfied:

(a) another sector count is input,

(b) the read/write for specified sector data is completed,

(c) a reset command <FBh> is input, and

(d) a power-on reset command <FDh> is input.

### 9. Sector Address

Sector addresses are logical addresses with fixed four cycles. The sector size is always 512 Bytes and the address range may theoretically be set up to 2 TBytes.

In read/write operation, a start sector address is defined regardless of the transfer data size. However, to achieve a higher speed performance, the start sector address is restricted as follows. That is, the start sector address needs to be restricted in such a way that it fits with the border of internal pages of the flash memory.

The sector address is input following a read sectors command <00h> or a write sectors command <80h>.

FIG. 18 illustrates a timing of sector addressing in four cycles.

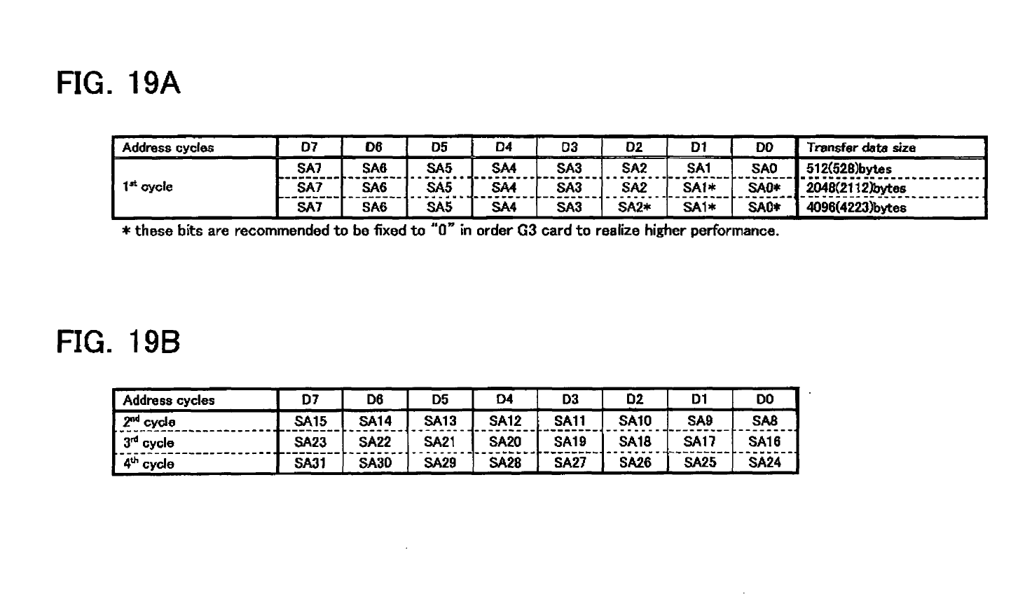

FIGS. 19(a) and 19(b) illustrate allocation of data pins to sector address bits for each cycle in relation to the transfer data size. If the transfer data size is 512/528 Bytes, then 8 bits SA0-SA7 in a first sector address cycle are assigned to respective pins D0-D7. If the transfer data size is 2048/2112 Bytes, then 6 bits SA2-SA7 in the first sector address cycle are assigned to respective pins D2-D7 and lower 2 bits SA0 and SA1 are fixed to, e.g., “0”. If the transfer data size is 4096 (4223) Bytes, then 5 bits SA3-SA7 in the first sector address cycle are assigned to respective pins D3-D7 and lower 3 bits SA0-SA2 are fixed to, e.g., “0”.

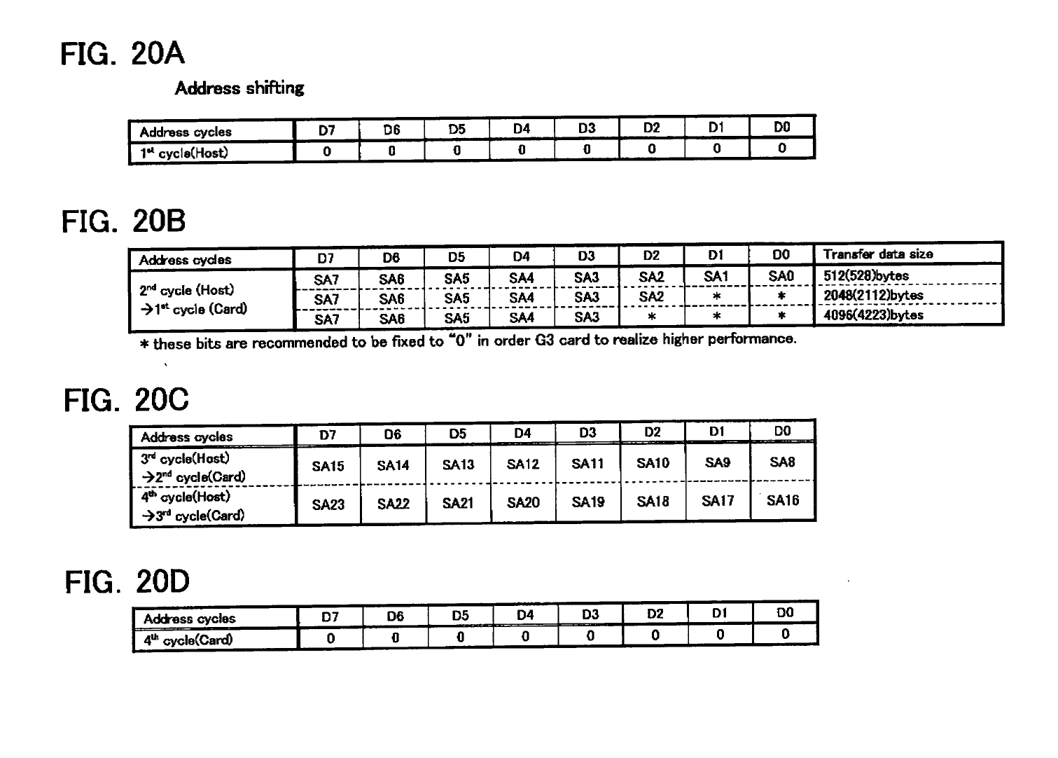

The bit “b4” of Byte 7 may enable the “address shifting”. According to this address shifting, a sector address is shifted as illustrated in FIGS. 20(a) through 20(d). That is, as illustrated in FIG. 20(a), a first cycle (host) becomes all “0”. In addition, as illustrated in FIG. 20(b), a second cycle (host) corresponds to the first cycle on the card side as in FIG. 19(a). Further, as illustrated in FIG. 20(c), third and fourth cycles on the host side correspond to second and third cycles on the card side, respectively. As illustrated in FIG. 20(d), a fourth cycle (card) becomes all “0”.

In other words, a sector address with four cycles on the host side substantially corresponds to a sector address with three cycles within the card. In a conventional xDP, the 4-cycle address includes the first cycle used as a column address, and remaining three cycles used as page addresses. In such a host, the first cycle might be fixed to “00”. In this case, it just might issue substantially three-cycle logical addresses to the G3 card. The address shift function limits the maximum of the card capacity to 8 GB, but it enables such the host to access to the G3 card.

### 10. Read Sectors

10. 1 Procedure of Read Sectors

The read sectors in the G3 mode is performed in accordance with logical sector addresses. The addressable range is determined by a “card configuration” command sequence that defines the total number of addressable sectors.

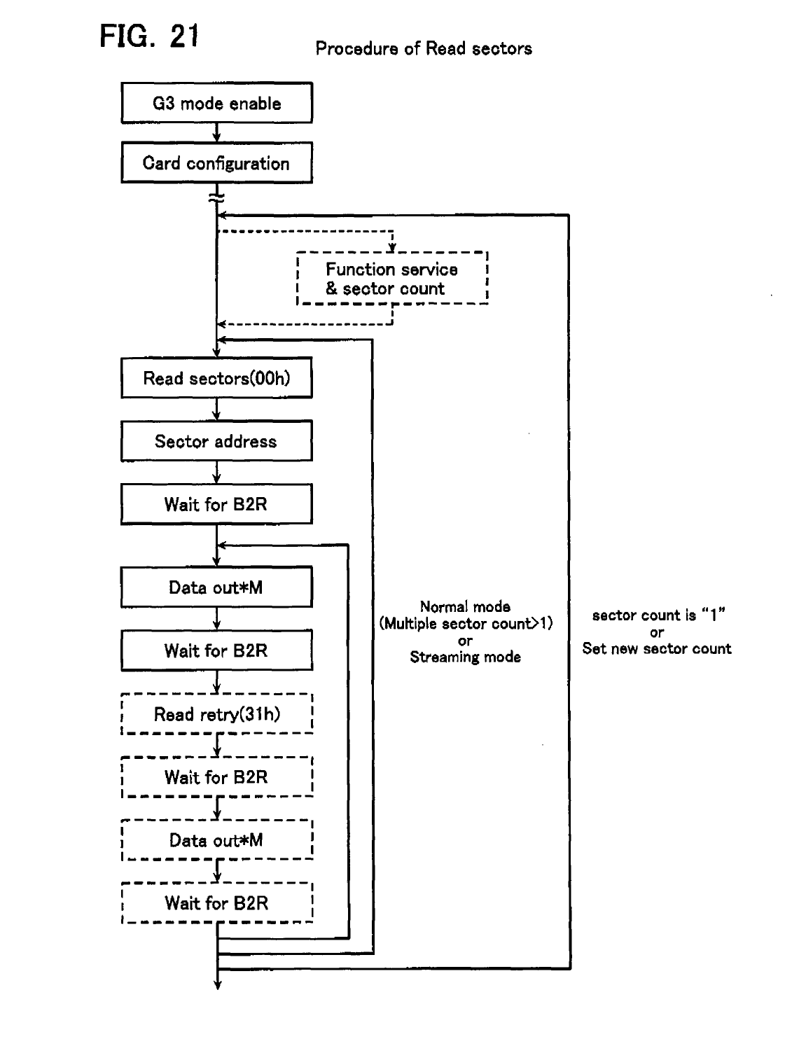

As illustrated in FIG. 21, prior to initiation of the read sectors, the host executes a “card configuration” command. As such, provided that a “function service & sector count” function is used, the “function service & sector count” command is executed to set several functions for the read sectors.

This command is followed by inputting a sector address with four cycles. Then, after a predetermined busy period, output data may be obtained with the amount of data defined by the sector address.

If the “function service & sector count” is not used, then only a basic access mode with a fixed transfer data size, 512 Bytes (or 528 Bytes), is valid for sector count=1.

Although the read sectors is initiated by inputting the command as well as the sector address, for multiple-sector counts and streaming read operations, there is no need to input a command <00h> and a sector address after the second cycle.

The error check of transfer data is performed using ECC or CRC16 codes in the extra 16-Byte region.

10. 2 Mode Setting for Read Sectors

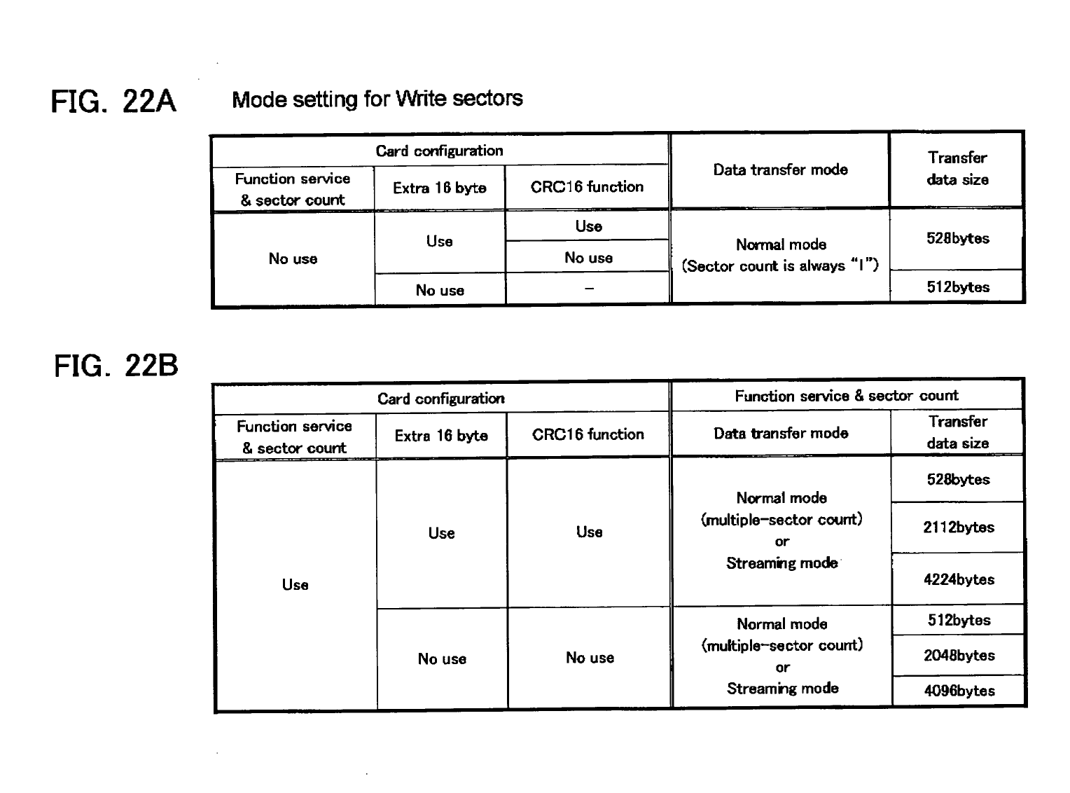

FIGS. 22(a) and 22(b) illustrate several types of modes defined in read sectors by the above-mentioned “card configuration” and “function service & sector count”.

When the “function service & sector count” command is not used, then the transfer data size is always 512/528 Bytes. In this case, since no sector count is set, the G3 card operates with sector count=1. Whether the transfer data size is 512 Bytes or 528 Bytes depends on whether or not extra 16-Byte region is used in the “card configuration”. The extra 16 Bytes is used as an ECC code region. If it is not used, then the extra 16-Byte region becomes all “FF”.

The transfer data size may be changed by means of the “function service & sector count” at any time. In addition, a mode that is based on a normal multiple-sector count or a streaming mode may be selected as a mode of transfer data. A difference between these modes is how the internal pre-loading is activated. That is, in the normal mode, the pre-loading in the card (reading from the flash memory) is controlled based on the sector count, whereas in the streaming mode, the internal pre-loading is performed automatically and continuously regardless of the sector count.

In read sectors, the host needs to carefully check for lack of data. In G3 mode, an ECC code is generated at extra 16-Byte region to perform error check and correction. That is, the host calculates and compares an ECC with the transferred ECC code.

If an uncorrectable error is detected, then the read sectors operation is once terminated and a value of sector count and a sector address are input to perform read sectors again. Alternatively, a user may select to read the same transfer data again without terminating the current read sectors function.

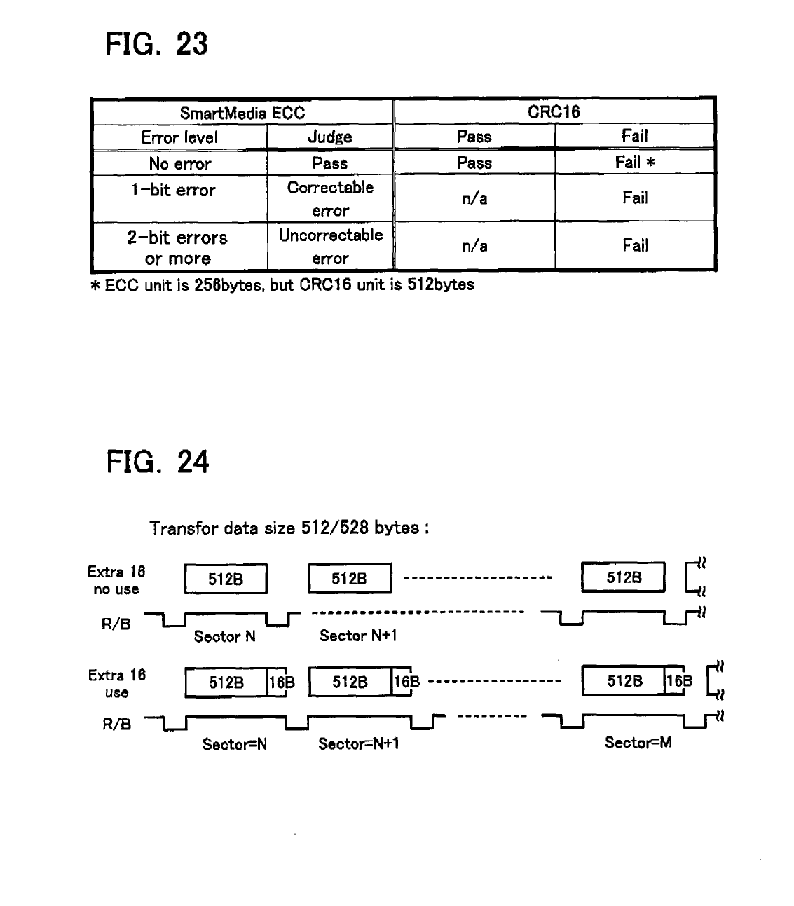

If the data may be corrected, then the host corrects the read data. However, since the ECC function has its own limitation due to a compatibility to conventional XDP, it may not detect and correct errors with 3 or more bits. In view of the above, the CRC16 is provided. That is, by selecting the CRC16 function, the host may determine whether the transfer data is “Pass” or “Fail” according to a table illustrated in FIG. 23.

10. 3 Data Format of Read Sectors

The host may determine the transfer data size. Each transfer data size has a limited number of selectable sector addresses, as described below.

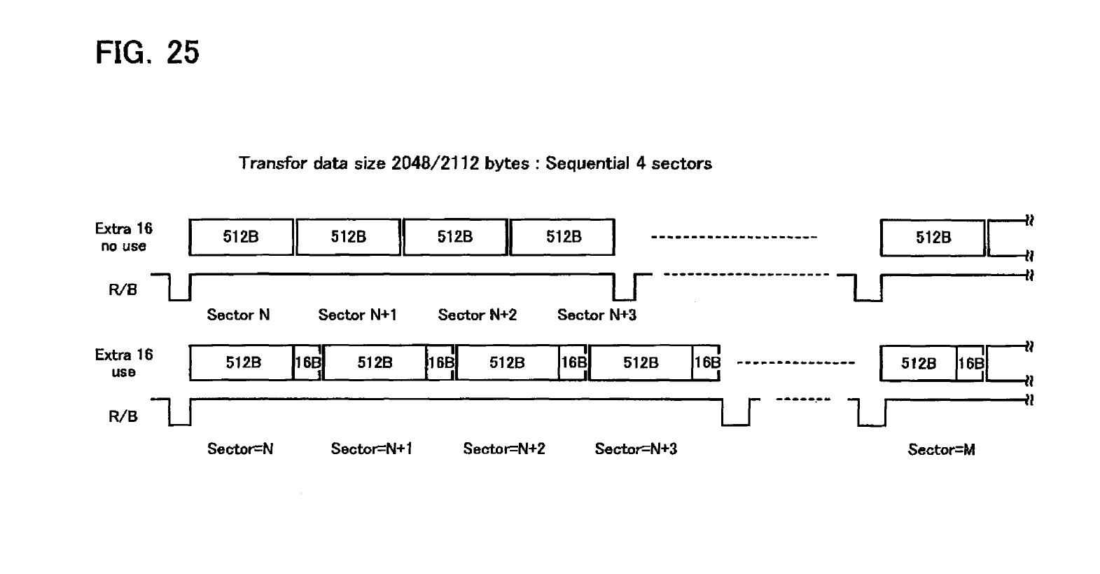

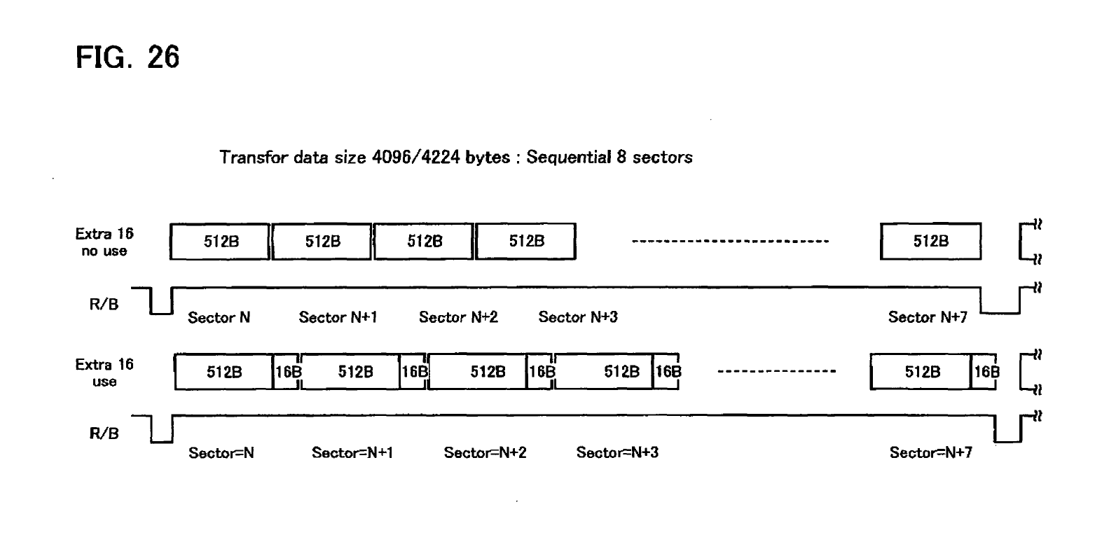

FIG. 24 illustrates the case where the transfer data size is 512/528 Bytes; and FIG. 25 illustrates the case where the transfer data size 2048/2112 Bytes with sequential four sectors. FIG. 26 illustrates the case where the transfer data size is 4096/4224 Bytes with sequential eight sectors.

As described above, the extra 16 Bytes added to 512 Bytes for each sector are set based on the “card configuration”.

10. 4 Data Format of Extra 16-Byte region

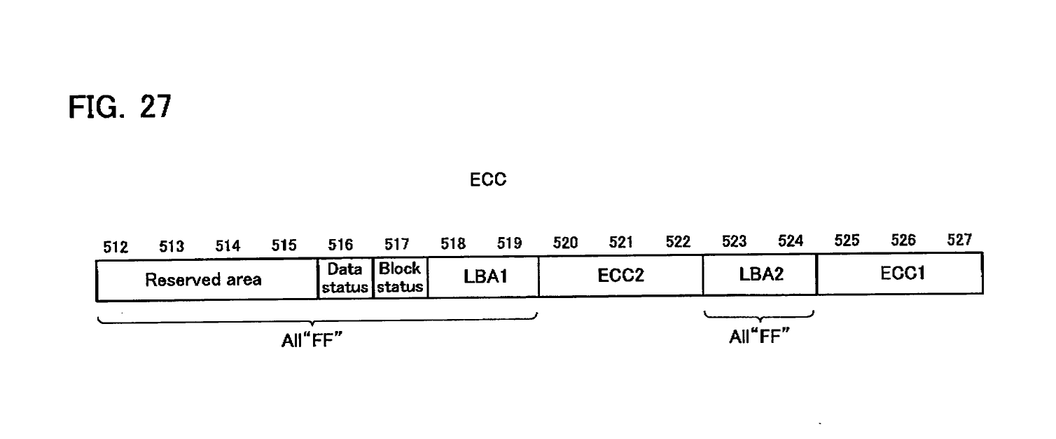

In the case of ECC, as illustrated in FIG. 27, the data format of the extra 16 Bytes is as follows: six Bytes of 520-522 Bytes and 525-527 Bytes are used as an ECC code region and the remaining Bytes become all “FFh”.

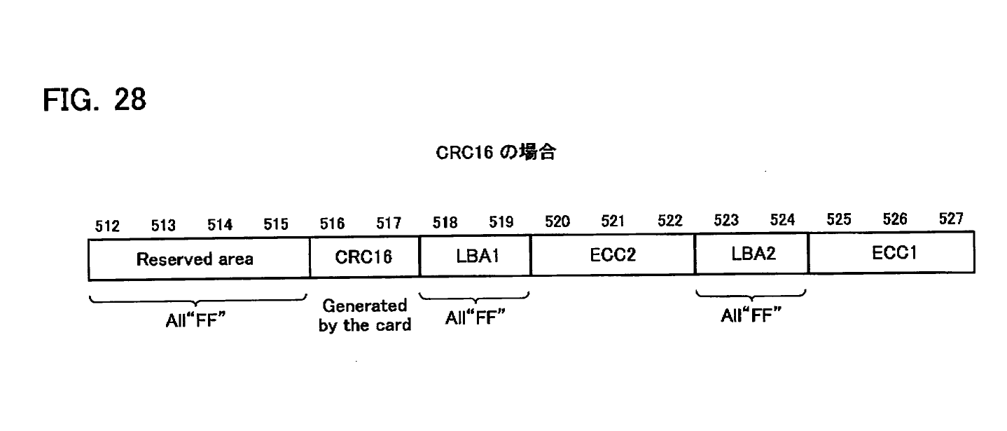

In the case of CRC16, as illustrated in FIG. 28, 526 Byte and 527 Byte are used as a CRC16 region and the remaining Bytes become all “FFh”.

10. 5 Protocols of Read Sectors

For example, if sector count (SC)=4, a command and a sector address <50h-add*4> with four cycles are input to set the read of SC=4, and a command and a sector address <00h-add*4> with four cycles are further input to instruct a read sectors. As a result, read data “Dout” is obtained that is consistent with SC=4.

Every time data is transferred, the G3 card indicates “dummy busy”. If the host continues to read more than the number of sector counts, then the read data becomes invalid data, e.g., all “FFh”, even if data read is performed after “busy” is indicated at the end of the read sectors.

If the host does not use the multiple-sector mode, then it needs to input a sector address for each read sectors. This is successfully applied to the multiple-sector mode. However, in the multiple-sector mode, the input of a command-sector address <00h-add*4> is preferably omitted after the second cycle so that sector data would be continuously read.

10. 6 Termination of Read Sectors

The read sectors may be forcibly terminated by a reset command <FBh> in a normal mode or a streaming mode. As a result, the sector count is cleared to “1”.

The read sectors may not be forcibly terminated by turning a chip enable/CE to “H” during a ready or busy period. This is different from the conventional xDP™ card.

10. 7 Relation between Read Sectors and Status Read

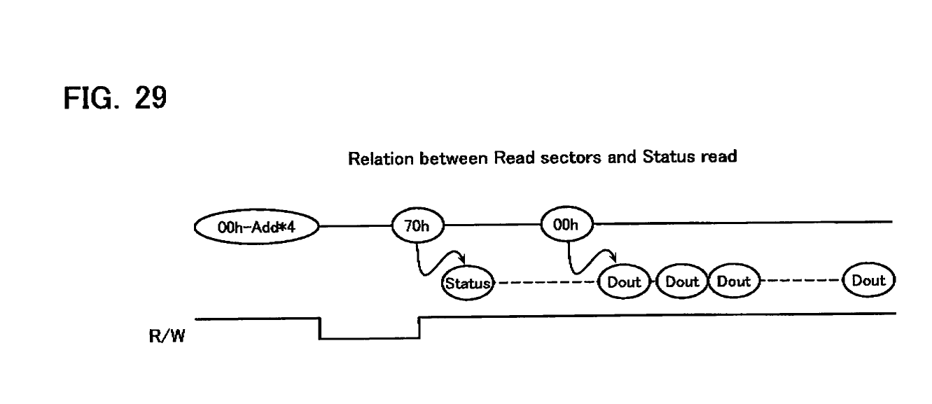

During a read sectors operation, the host may issue a status read command <70h>. In this case, as illustrated in FIG. 29, the host must issue a command <00h> after the status read and before a read data output operation is initiated by outputting a read enable/RE.

10. 8 Relation between Read Sectors and Buffer R/W

During a read sectors operation, the host may issue a buffer read/write command <71h> (described in detail below). Also in this case, as illustrated in FIG. 30, the host must issue a command <00h> before a read data output operation is initiated by outputting a read enable/RE.

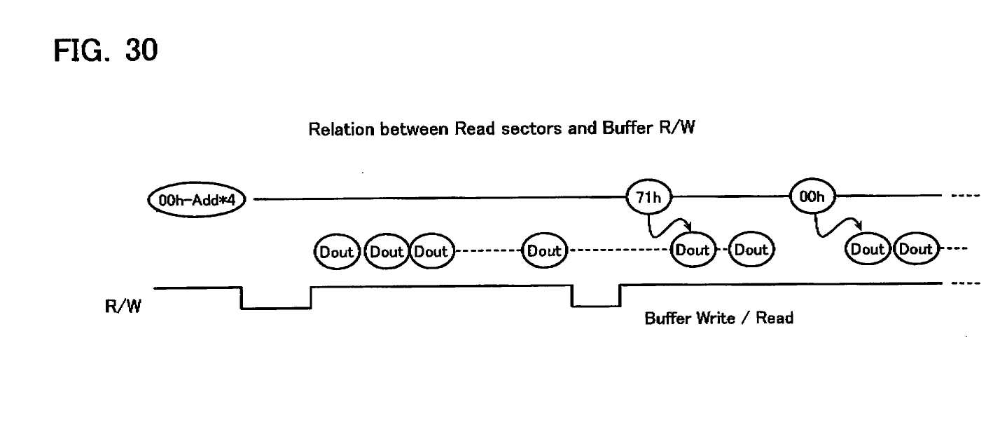

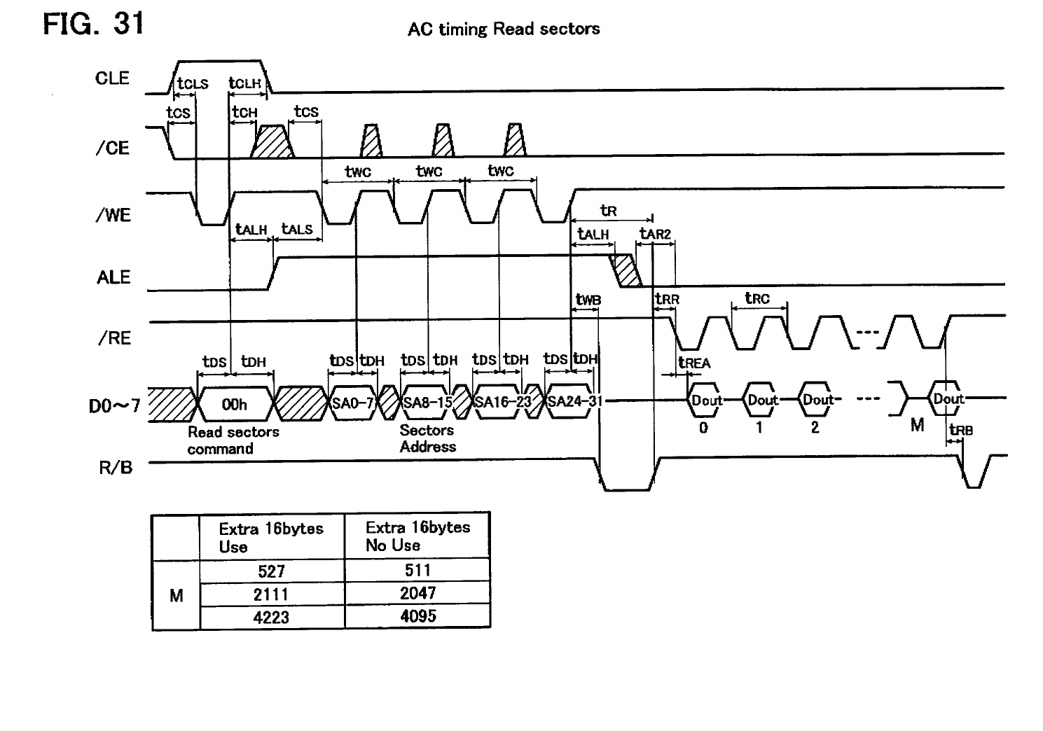

FIG. 31 illustrates a timing waveform of read sectors. A second cycle SA8-15 is a substantial sector address of the sector addresses with four cycles and the following two cycles SA16-23 and SA24-31 are sector counts.

### 11. Write Sectors

11. 1 Procedure of Write Sectors

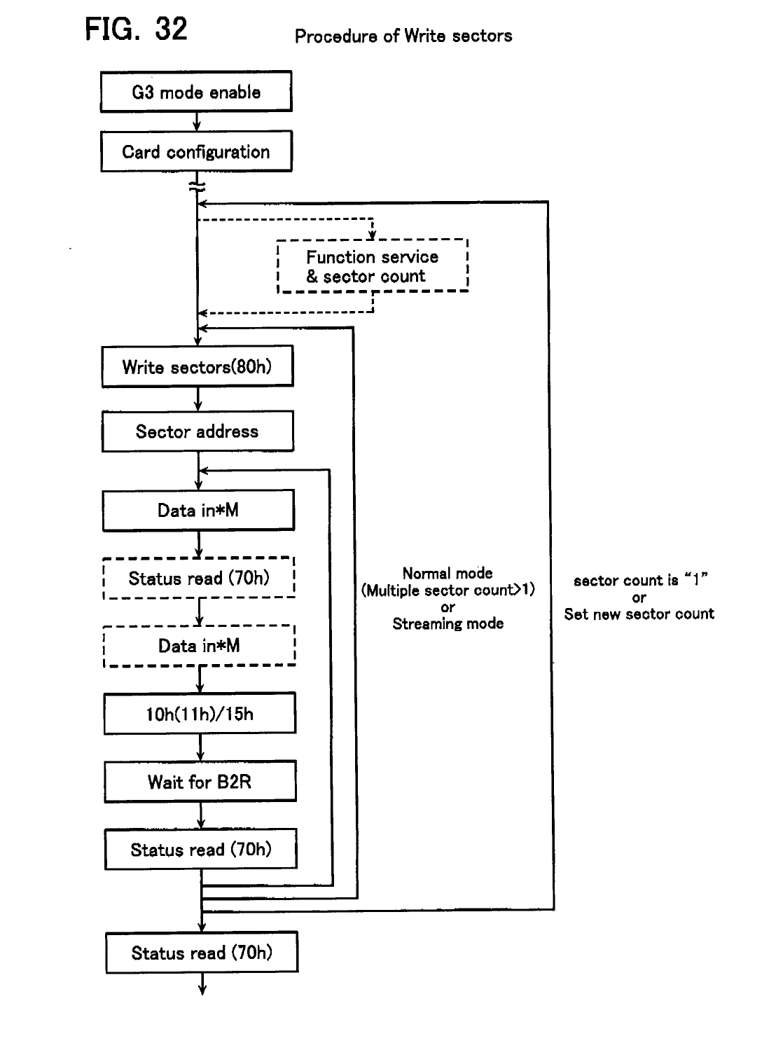

FIG. 32 illustrates a procedure of write sectors. The write sectors is performed based on logical sector addresses. The addressable range is defined as all accessible sectors by execution of a “card configuration” command that is executed after a “G3 mode enable”. When a user selects to use a “function service & sector count” in the “card configuration”, the host needs to execute a “function service & sector count” command before the write sectors is initiated.

In the “function service & sector count”, a plurality of functions may be set. However, when the “function service & sector count” is not used, it is also possible to perform a basic access operation and a write operation maybe performed with a fixed transfer data size of 512/528 Bytes when sector count=1.

The write sectors is initiated by inputting a command <80h>, a sector address, and write data. In the case of multiple-sector counts and streaming mode, there is no need to input a command <80h> and a sector address after the second cycle.

The host checks for errors of transfer data through the status read <70h> that is performed after the data is transferred. If any error occurs, a status read value, i.e., the bit “b2” becomes “1”, which is retained during the write sectors. The write sectors may be continued regardless of the status read.

11. 2 Mode Setting for Write Sectors

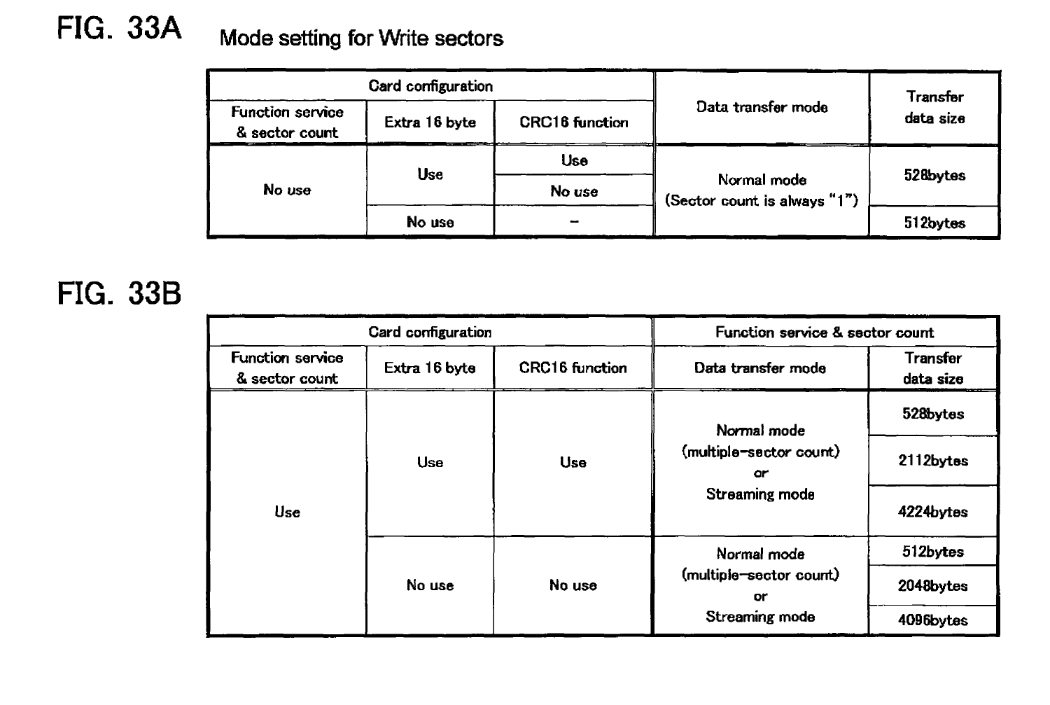

FIGS. 33(a) and 33(b) illustrate several types of modes defined by the above-mentioned “card configuration” and “function service & sector count” in the write sectors.

When a “function service & sector count” command is not used, the transfer data size is always 512/528 Bytes. In this case, since no sector count is set, the G3 card operates with sector count=1. Whether the transfer data size is 512 Bytes or 528 Bytes depends on whether or not the extra 16 Bytes are used in the “card configuration”. The extra 16 Bytes is used as an ECC. If it is not used, then the extra 16-Byte region becomes all “FF”.

The transfer data size may be selected in the “function service & sector count”, which may also be changed at any time. In the transfer data mode, either a normal mode (multiple-sector counts) or a streaming mode may be selected.

Since various transfer data sizes for write operation may be set, such overhead may be eliminated as in conventional memory cards with a fixed block size for write operation. That is, in those conventional memory cards, such operations were required to erase any blocks with large capacity and write data thereto, even if the amount of data to be updated is small.

In contrast, with respect to the G3 card of this embodiment, the transfer data size maybe selectively set. Further, there is no restriction that corresponding blocks must be erased prior to write operation. Consequently, a high speed write performance may be obtained.

For the ECC function, any data transfer error should be detected between the host and the G3 card. That is, transfer data from the host is subject to the error check of transfer data that is automatically performed at the G3 card side based on the ECC function. Prior to a write operation, the host may know in advance whether the transfer data is “Pass” (including a correctable error) or “Fail” (an uncorrectable error) through the status read.

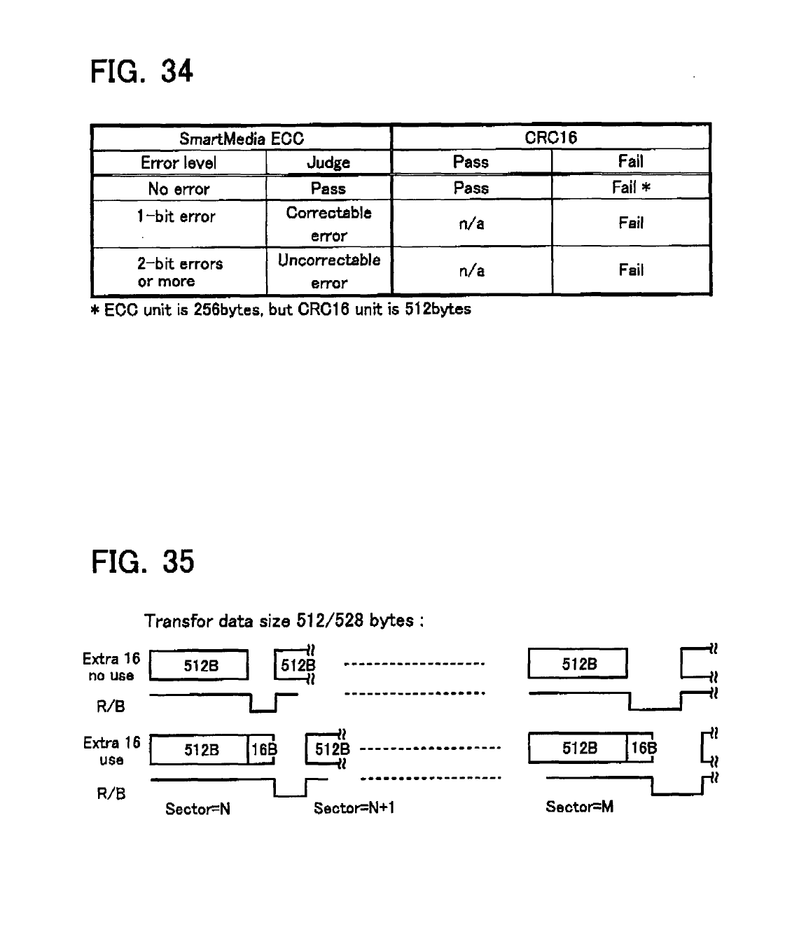

In the write sectors, the host needs to carefully check for lack of transfer data. The ECC function is not configured to accommodate errors with 3 or more bits. As such, the CRC16 is provided that can detect Pass/Fail regardless of the number of errors. If this function is validated in the “function service & sector count”, then a determination may be made as to whether transfer data is Pass or Fail according to a table illustrated in FIG. 34.

11. 3 Data Format of Write Sectors The host may determine the transfer data size. That is, extra 16 Bytes may be validated in the “card configuration”, if required, to provide such a sector data size of 528 Bytes that corresponds to each sector unit of 512 Bytes added with 16 Bytes.

FIG. 35 illustrates each transfer data size of 512/528 Bytes in respective cases of the extra 16 Bytes being not used and the extra 16 Bytes being used.

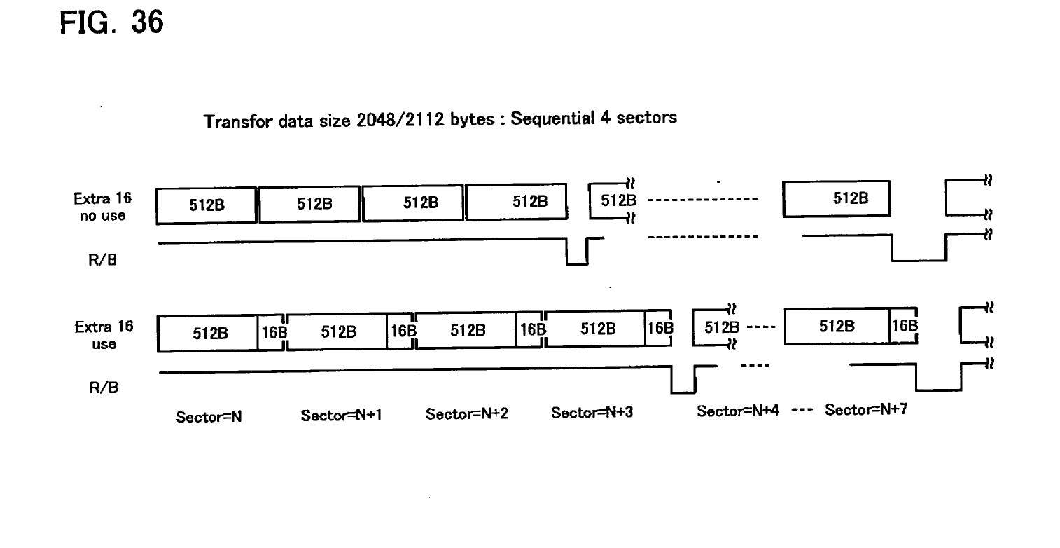

Similarly, FIG. 36 illustrates each transfer data size of 2048/2112 Bytes when sequential four sectors are written, in respective cases of the extra 16 Bytes being not used and the extra 16 Bytes being used.

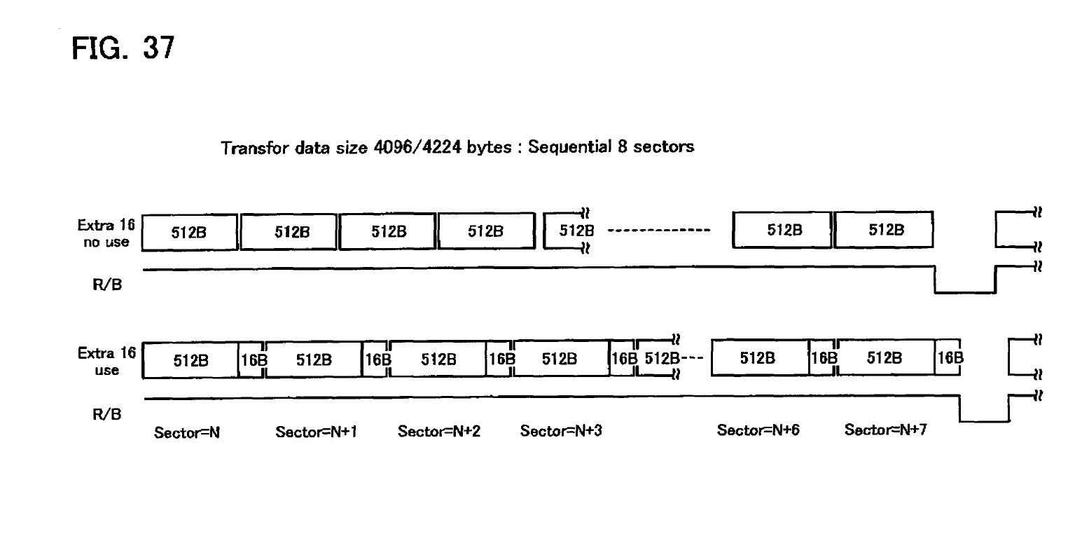

Similarly, FIG. 37 illustrates each transfer data size of 4096/4224 Bytes when sequential eight sectors are written, in respective cases of the extra 16 Bytes being not used and the extra 16 Bytes being used.

11. 4 Data Format of Extra 16-Byte Region

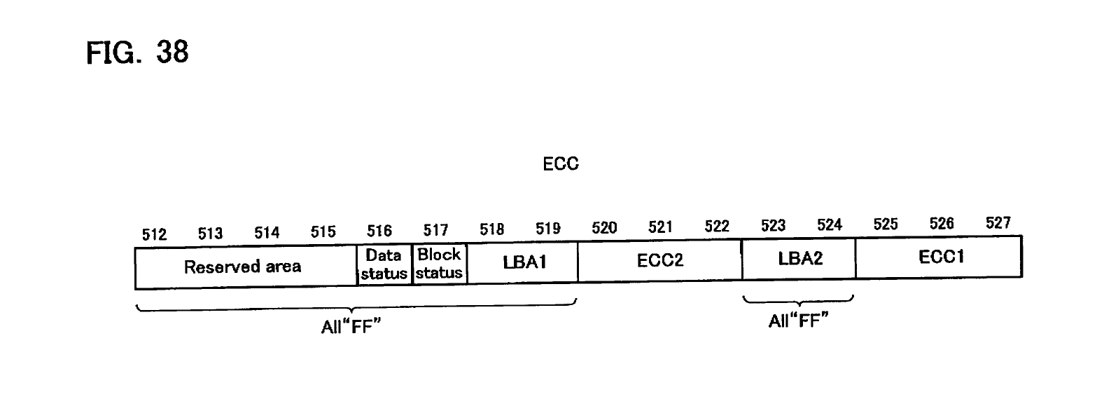

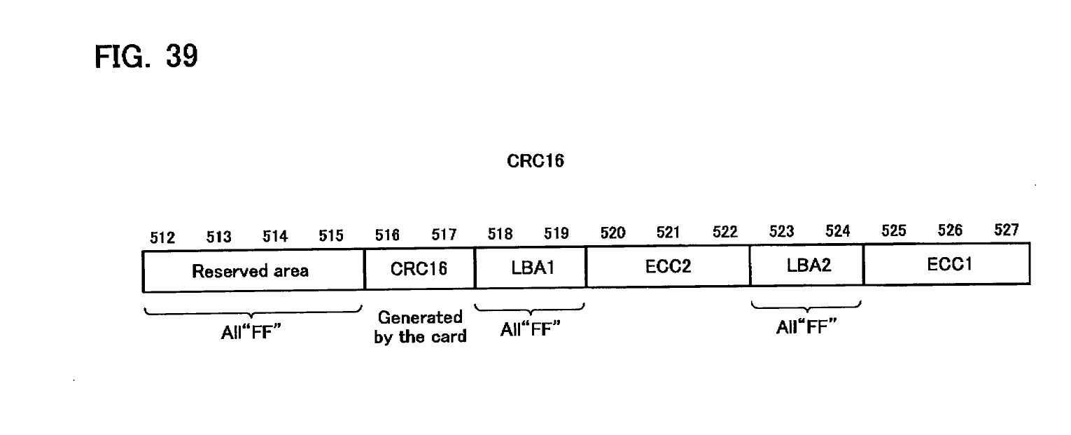

The data format of extra 16 Bytes is as illustrated in FIGS. 38 and 39, each corresponding to the case of ECC and CRC16. These drawings are similar to FIGS. 27 and 28 regarding the read sectors.

11. 5 Protocols of Write Sectors

There are two protocols of write sectors. One is a recommended for write multiple-sector modes, where the input of a command-sector address <80h-add*4> is not required after the second cycle and sector data may be continuously written.

In the other protocol, a command-sector address <80h-add*4> is input for each write sectors. This is a mandatory mode for accesses with SC=1. Although this command scheme may be applied to the write multiple-sectors mode, another mode is preferably used where the input of sector addresses is omitted.

In write operations based on the multiple-sector scheme, the host needs to transmit all data defined by the transfer data size. For example, if the transfer data size is 2048 Bytes and if sector count=3, the first three sectors are accurately written to the card and the remaining one sector is not.

For a better understanding of the write sectors, further reference is made to a normal mode (multiple-sector counts) and a streaming mode.

In the normal mode, the sector count and the transfer data size are defined in the “function service & sector count”. Then, the host instructs initiation of the write sequence by a command <80h>. Upon receipt of a command <15h(11h)> issued after the address and write data are input, the G3 card initiates the data write.

If error check of transfer data is required, then the host performs status read before transmitting a initiation-instruction command <15h(11h)>. When the sector count becomes “1”, the host issues a command <10h> instead of the command <15h> to terminate the write sectors.

If the “function service & sector count” is not used, the sector count is always “1”.

The streaming mode is also set in the “function service & sector count”. In this mode, the host uses the protocol of the command <80h> to initiate a write operation. Upon receipt of the command <15h(11h)>, the G3 card initiates the write operation. If error check of transfer data is required, then the host performs status read before transmitting the command <15h>. The host issues a command <10h> instead of the command <15h> to terminate the streaming mode.

11. 6 Suspension of Write Sectors

The host may suspend a write operation with commands before the sector count becomes SC=1 or the streaming write operation is terminated. Specifically, the suspending operation is based on, a reset command <FBh>, a power-on reset command <FDh>, a power-down command <FEh>, etc.

Upon receipt of these commands, the G3 card terminates its internal write operations.

11. 7 Other Possible Functions in Write Sectors

A CIS read and a buffer read/write described below may be performed without suspending the read sectors. However, to resume a write sectors after the CIS read and the buffer read/write, a command sequence of <80h> . . . <10h> is required.

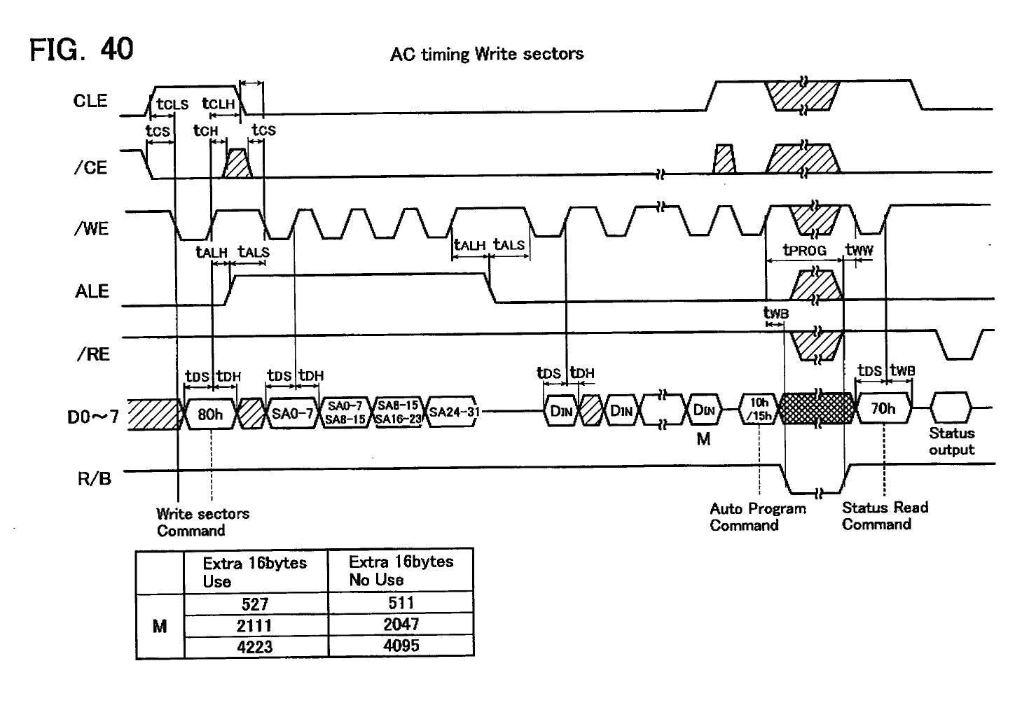

FIG. 40 is a timing diagram of write sectors. A sector address with four cycles and necessary write data, which are sandwiched between commands <80h> and <10h/15h>, are transferred to perform a write operation. The structure of the write sectors address with four cycles is similar to that of the read sectors. During the write operation, the card outputs “busy”.

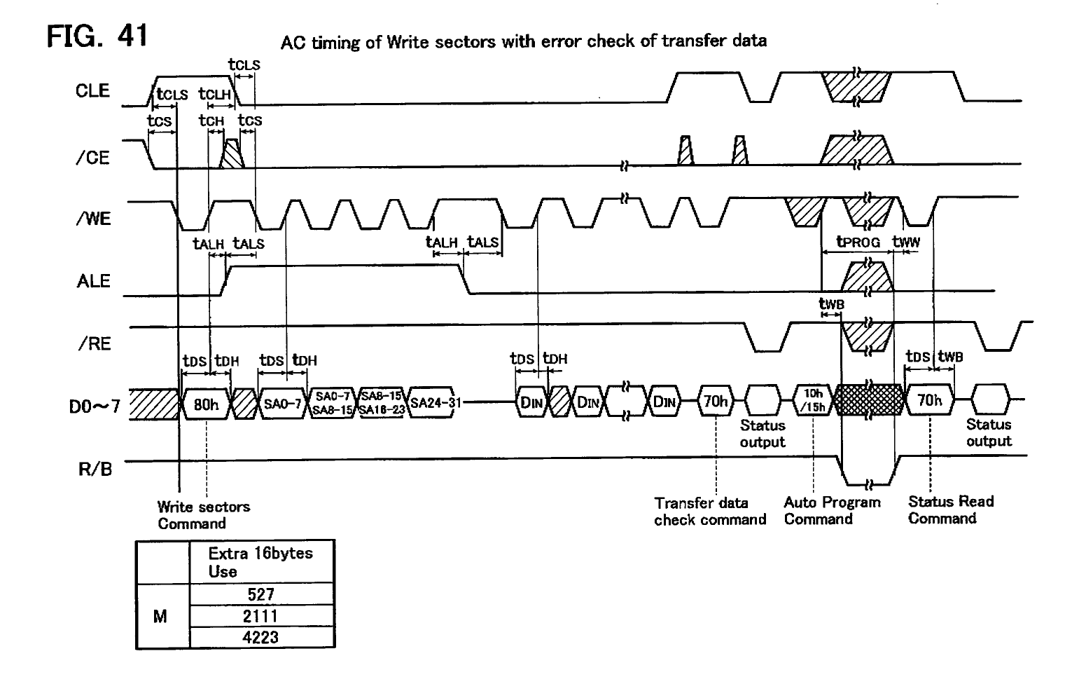

FIG. 41 is a timing diagram of write sectors including a transfer data check operation. After the write data is input, the transfer data check may be performed based on a command <70h>.

### 12. Host Cache Write

The G3 card has several cache systems to prevent performance degradation due to a random access to certain data. Generally, overwriting of logical sectors or writing to a random address causes an internal data swapping, which would result in overhead that leads to performance degradation. For example, such situations arise when a random access is performed in updating FATs, directories, or certain image or movie data.

The cache systems used in the G3 card provide a special logical/physical address translation table to perform data write in such a way that the internal data swapping is minimized.

For example, the following cache systems are provided:

(a) FAT Cache System

If the host writes certain data to a special logical address, that data is handled by the cache system. For example, logical sector addresses in a FAT region are obtained via DOS format parameters (described below), and the cache system is operated in relation to the logical address.

(b) Directory Cache System

If the host accesses a directory region, the sector count is minimized, and the logical address tends to jump to an address that is greatly separated from the write address such as image data and the like. The data transferred by an access pattern with such a tendency is dealt by the cache system.

Most random accesses may be covered by the above-mentioned algorithm. However, in view of a more effective control, the host preferably determines which logical address should be written to the cache region. Since the number of blocks for the cache systems is limited, the host needs to carefully determine which logical sector should be written to the cache block. If the cache block is already full, older data in the cache block or data with a low access frequency is transferred to normal blocks to ensure regions for storing the new data to the cache block.

### 13. Status Read (70h)

The status read is performed to, e.g., monitor the Busy/Ready states of the card and determine whether the write operation is Pass/Fail. These states of the card are output to an I/O port by toggling the read enable/RE after the command <70h> is input.

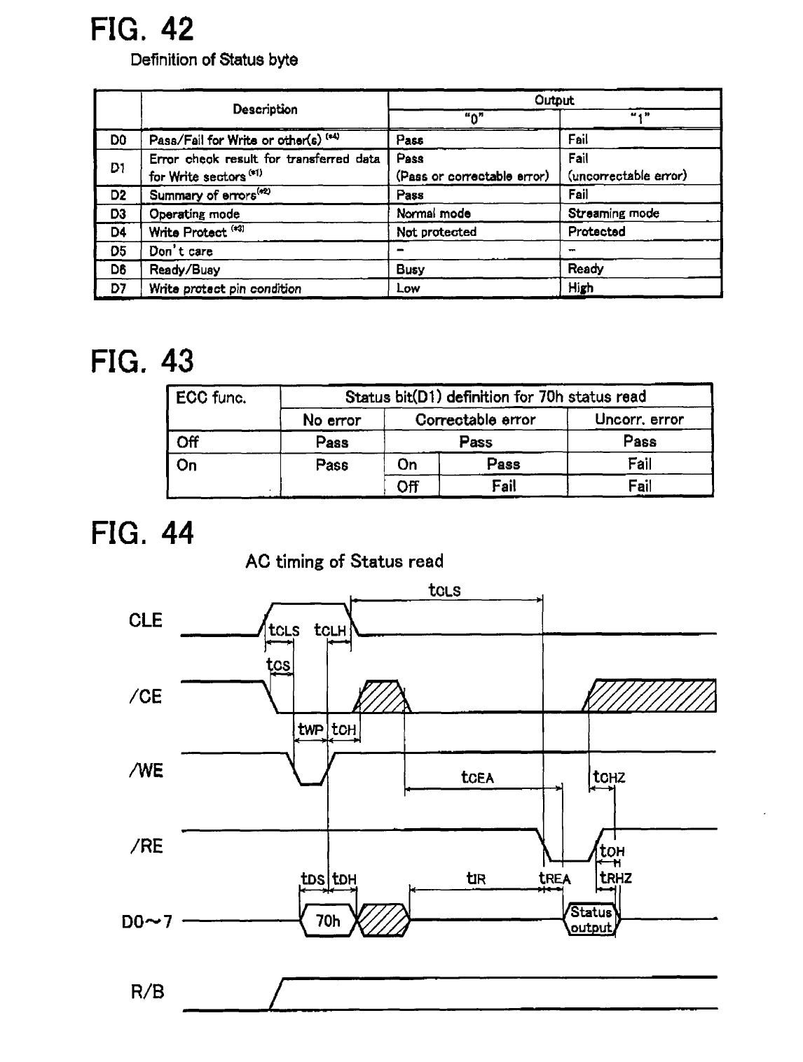

FIG. 42 illustrates the results of status read. The results of the error check for D1 becomes “1” (Fail) if an error occurs in at least one sector of the transfer data size of 2048 (or 4096) Bytes. If extra 16 Bytes are used in the ECC function, and if the ECC function is on, then the result of Pass/Fail is output to the bit D1. If the ECC is “Pass”, and if the error is determined to be correctable, then “Pass” is obtained. Similarly, if extra 16 Bytes are used in the CRC16 function, then “Pass” or “Fail” is output accordingly. D1 bit is cleared in the next data transfer operation.

If D1 is “Fail”, then D0 is always “Fail”.

Once an error occurs in transferring data or writing sectors, D2 indicates “1” (Fail) until a new write sectors is performed.

If the G3 card is protected in the “card configuration”, then D4 remains “1” (protected) until power down.

FIG. 43 illustrates states of the status bit (D1) that result from the above-mentioned status read in relation to on/off of the ECC function.

FIG. 44 illustrates an AC timing of the status read.

### 14. CIS Read

Since the G3 card accesses on the basis of logical addresses, it is necessary to define a read method for CIS (Card Information Structure) data.

For example, the purposes of the CIS read includes: (a) identifying a card that is formatted according to the xDP™ physical format, (b) identifying the supplier of the card and achieve special features of DSC, and (c) checking the connection state between the host and the card. Note that, in an conventional xDP card, The CIS data is written to the beginning of the effective physical block of the flash memory.

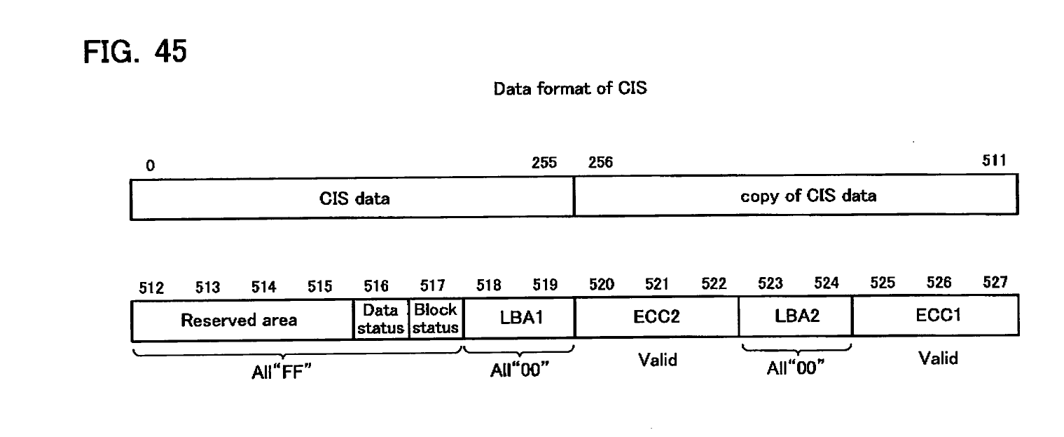

FIG. 45 illustrates a data format of CIS.

### 15. Buffer Read/Write

The G3 card has a buffer read/write function to quickly check the connection state between the host and the card. When 1 Byte of data is written by the host together with a specific command, the inverted data should be read and output.

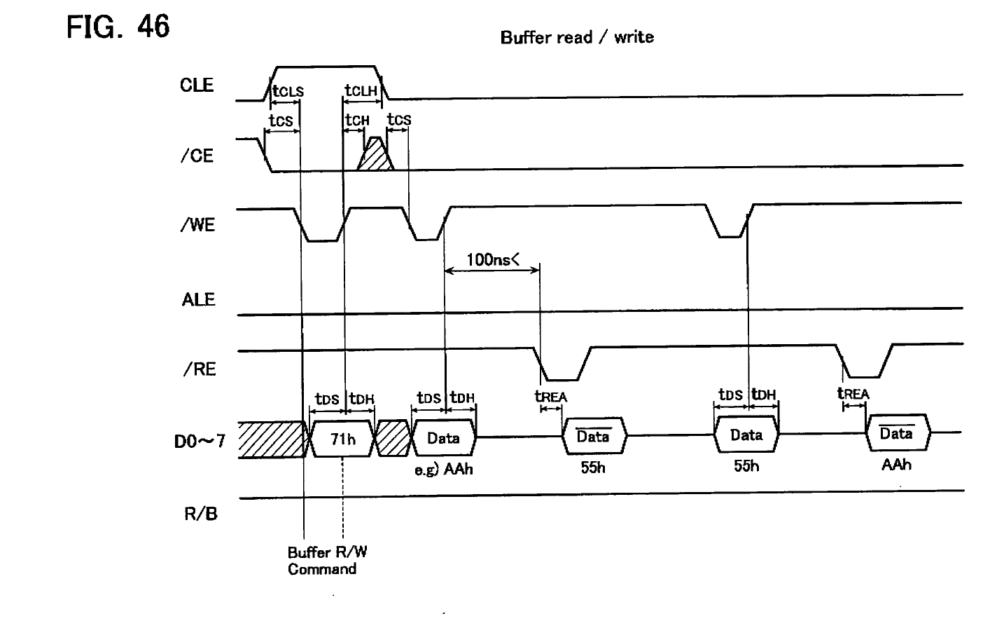

FIG. 46 illustrates a timing diagram where the above-mentioned function is achieved. For example, this function may be used during read sectors operations. The host transmits a command <71h> and 1 Byte of data, e.g. , “AAh”. Upon input of a read enable/RE after a latency of on the order of 100 ns, if the connection is in normal state, then inverted data of the written data “55h” should be output. This enables checking the connection state.

16. Reset The G3 card has two types of reset commands. One is a power-on reset command <FDh> for resetting hardware, and the other is a command <FBh> for resetting software.

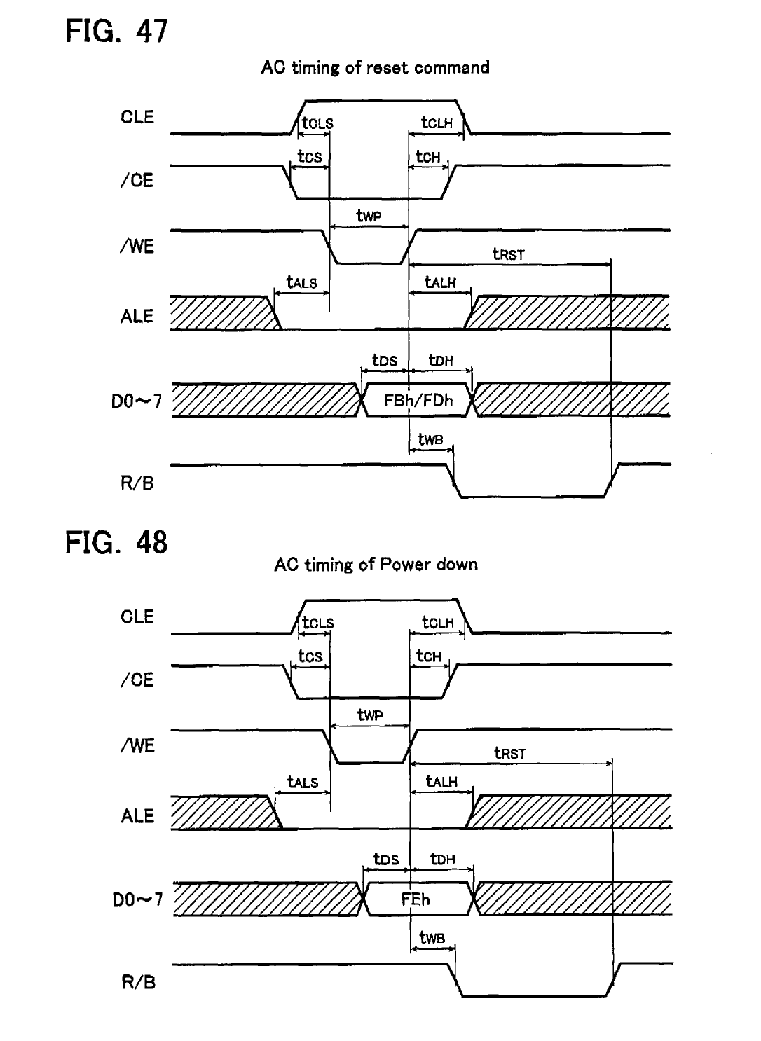

FIG. 47 illustrates an AC timing of these reset commands. If the host issues the power-on reset command <FDh>, then the “card configuration” is also reset and the G3 card is cleared to the default state of immediately after power-on.

The reset command <FBh> is a command that is used by the host to forcibly terminate read sectors or write sectors operations performed by the G3 card. If the reset command <FBh> is issued during a busy period of the write sectors, then these operations are terminated after the write sectors operation is completed so that loss of write data is prevented.

The recovery time (B2R) depends on internal conditions. The “function service & sector count” is cleared by the reset command, while the “card configuration” is not cleared and left with its current content.

### 17. Power-Down

FIG. 48 is a timing diagram of a power-down command <FEh>. The host needs to output the command before power-down of the G3 card. This is done for the purpose of preventing the command from being lost due to the power-off when such data still remains in the G3 card that has been retained in the cache.

That is, upon issuance of the command <FEh> by the host, the G3 card turns into a busy state (R/B=“L”) and performs an operation (“flash”) to write all data that remains in the cache to the flash memory. In response to R/B=“H”, the host turns off the power. This prevents unnecessary loss of data.

### 18. Auto DOS Format

Generally, in the xDP™ card system, the DSC (DOS) format is defined for the following three purposes:

(a) to clear DOS parameters,

(b) to erase all physical blocks as a pre-erasing, and

(c) to completely erase user data (for security purpose).

The G3 card that uses an LBA scheme also needs (a) and (c). Generally, for (a), the host may write original DOS parameters to clear all file information, which will not take much time. On the other hand, for (c), since the G3 card assumes that the host does not have a function for erasing physical blocks, it is necessary to rewrite all user data to “00” according to logical sector access, which can take a significant amount of time. This is because, when the host rewrites data in a logical address, the G3 card itself searches for an empty block to write such data and erases data in a position to which the original logical address is assigned.

In view of the above, this embodiment provides an “auto DOS format” command According to this function, the G3 card will substantially erase user data in a rapid manner by clearing DOS parameters and overwriting the user data region with all “00”.

The 32-bit FAT is used for DOS parameters and optimized so that the G3 card exhibits a high performance.

After the “auto DOS format” command is executed, the reset command <FBh> is required

### 19. Low Level Format

A “Low level format” command for erasing physical blocks is provided to completely clean up internal data. The “Low level format” command has the same function as that of the “auto DOS format” command, except for the erase operations.

The time for erasing depends on the card capacity (i.e., the number of physical blocks), which cannot be known by the host. Therefore, in order to distinguish a period of erasing operation from a normal busy period by the host, the card preferably outputs internal states of the operation counter, e.g., based on a status read request command <73h> from the host.

Preferably, this function is also used at the above-mentioned “Auto DOS format”.

After the “Low level format” command is executed, the host needs to issue a power-on reset command <FDh>. In addition, it is again necessary to obtain and set the “card configuration”.

### 20. Special ID Data Read

The G3 card has a “Unique ID” of special ID data that a user is only allowed to read using a special command. The “Unique ID” is written before shipment of the card and so cannot be rewritten by any user.

After the ID read command is executed, it is necessary to issue a reset command <FBh>.

### 21. Inheritance Function

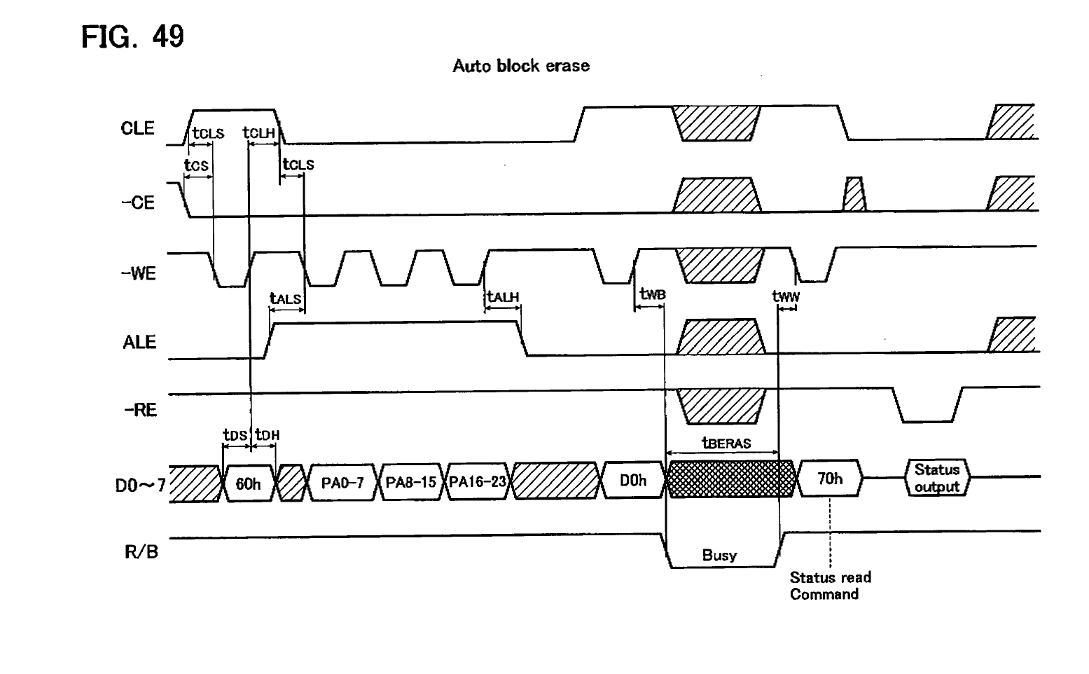

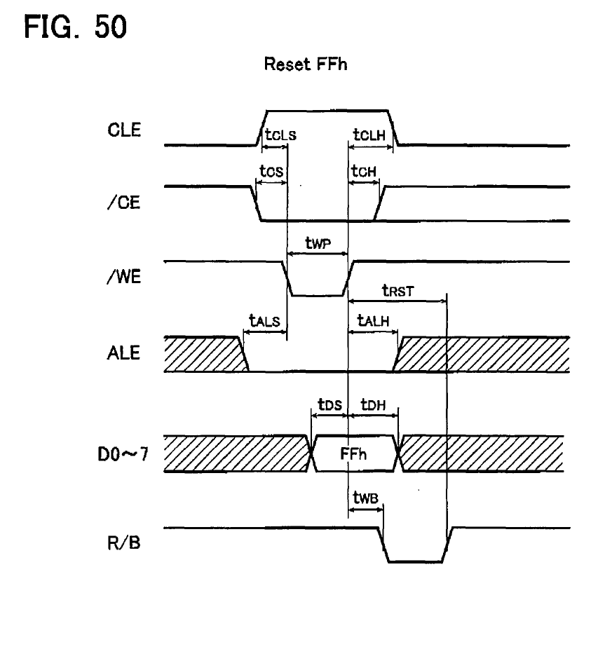

The G3 card still holds some functions of the G1 or G2 card generation: (a) an auto block erase function, and (b) an FFh reset function. The former function (a) is to input physical addresses according to the timing diagram of FIG. 49 to erase blocks. The latter function (b) is to clear sector addresses and sector counts according to the timing diagram of FIG. 50.

Although the G3 card internally treats these functions as non-operative (NOP), it externally outputs “dummy busy” (1.5-2 μs). In addition, it responds with “Pass” to the status read of the host.

### 22. Pass-Through Mode

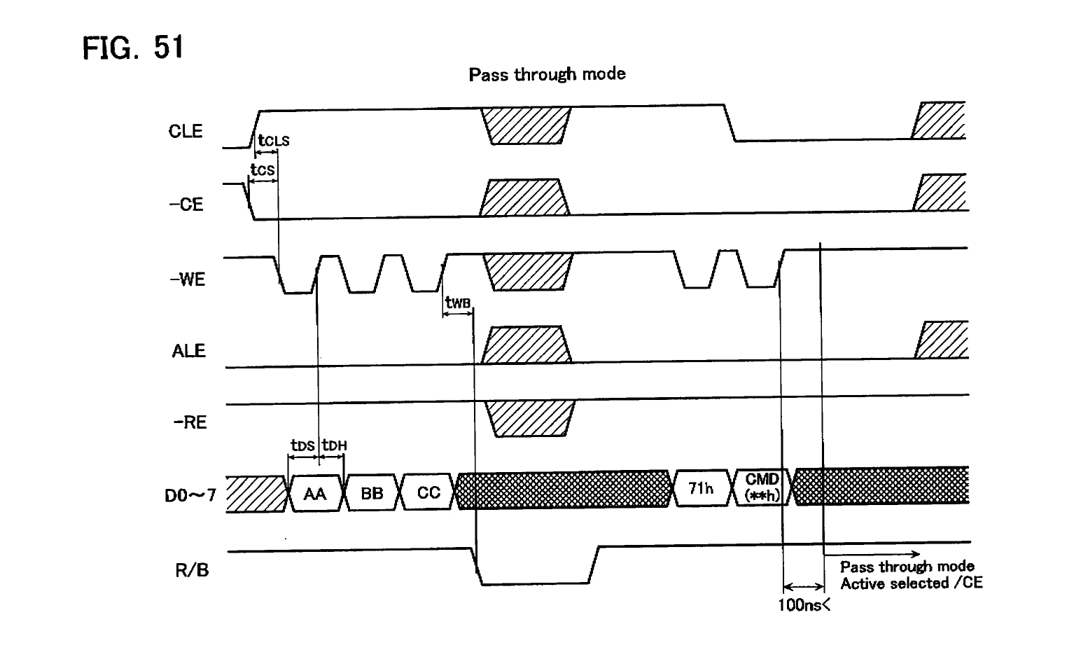

The G3 card may set a “Pass-through mode” mainly for testing the flash memory. In this mode a built-in controller does not interpret corresponding commands. Instead of this, a mode change is conducted wherein an access from a host device to a host I/F within memory card is directly transferred to the NAND flash memory. As illustrated in FIG. 51, three-staged commands <AA>-<BB>-<CC> are used to prevent malfunction.

For example, this mode may be applied to any of the following cases: when there is no firm ware (FW), when there is FW, and when there is FW but it has damaged (e.g., cannot be rebooted).

The pass-through mode is achieved by a hardware sequencer at the memory controller within the card. In a flash memory test, commands <71h>-<CMD (**)> are also input subsequent to the above-mentioned commands so that any one of chip-enable signals/CE0 through/CE3, corresponding to the plural flash memory chips, is selected (alternatively, all of these are concurrently selected).

During the flash memory test, the CPU in the controller enters sleep state to reduce power consumption associated with the text. This mode continues until a reset command is issued or power-down occurs.

### Additional Embodiments

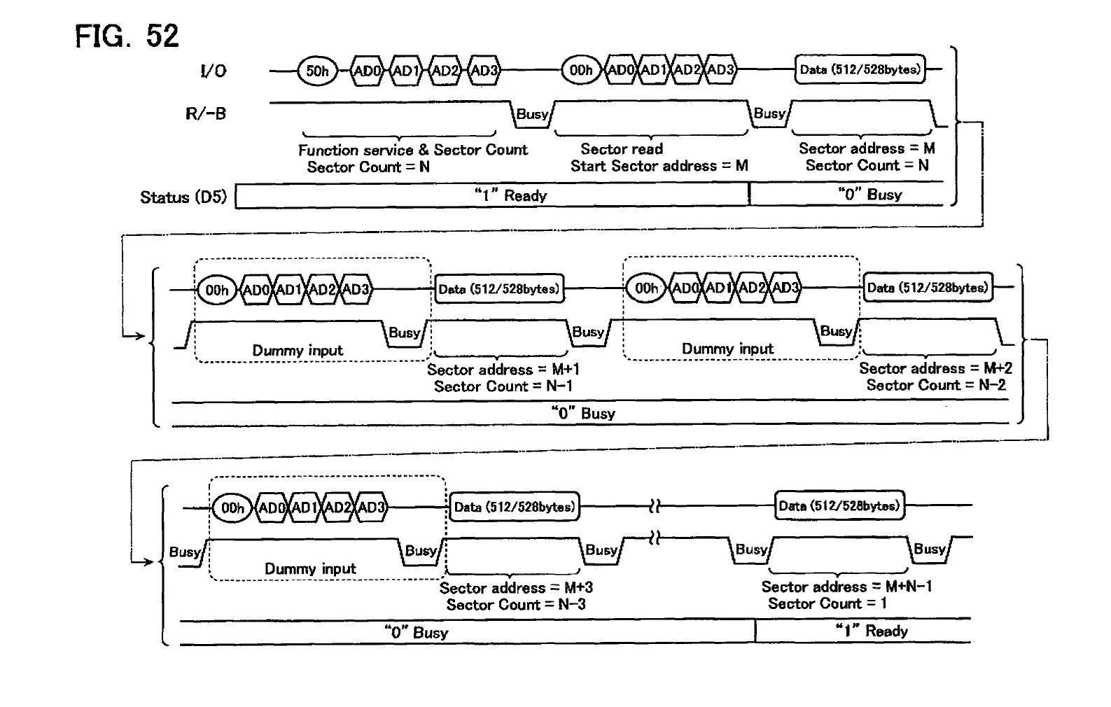

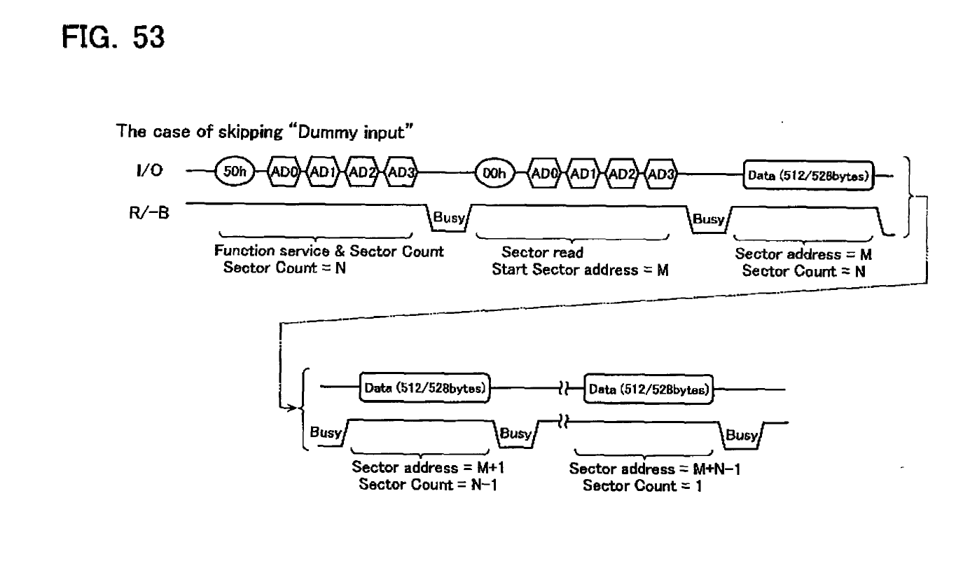

FIGS. 52 and 53 illustrate a protocol of read sectors where sector counts are set. These drawings illustrate a busy state (D5=“0”) to be continuously exhibited from the first data read to arrival of the last data packet of read sectors, using a input/output pad D5 in “Status” read in addition to internal Ready/Busy. The “Status” read involves the following command sequence: <70h>-[Status value]. If data read is still continued after [Status value] is read, then <00h> is input to return to the data read mode. The same applies to the write operation.

The length of transfer data is selected from 512 Bytes×N or (512+16 Bytes)×N depending on the transfer protocol. The 16 Bytes added to the data length is used for checking transfer data based on CRC, ECC, etc.

After the first sector address is input, a dummy sector address is input to continue the read operation.

FIG. 53 illustrates a case of skipping input of a dummy sector address after the first sector address is input.

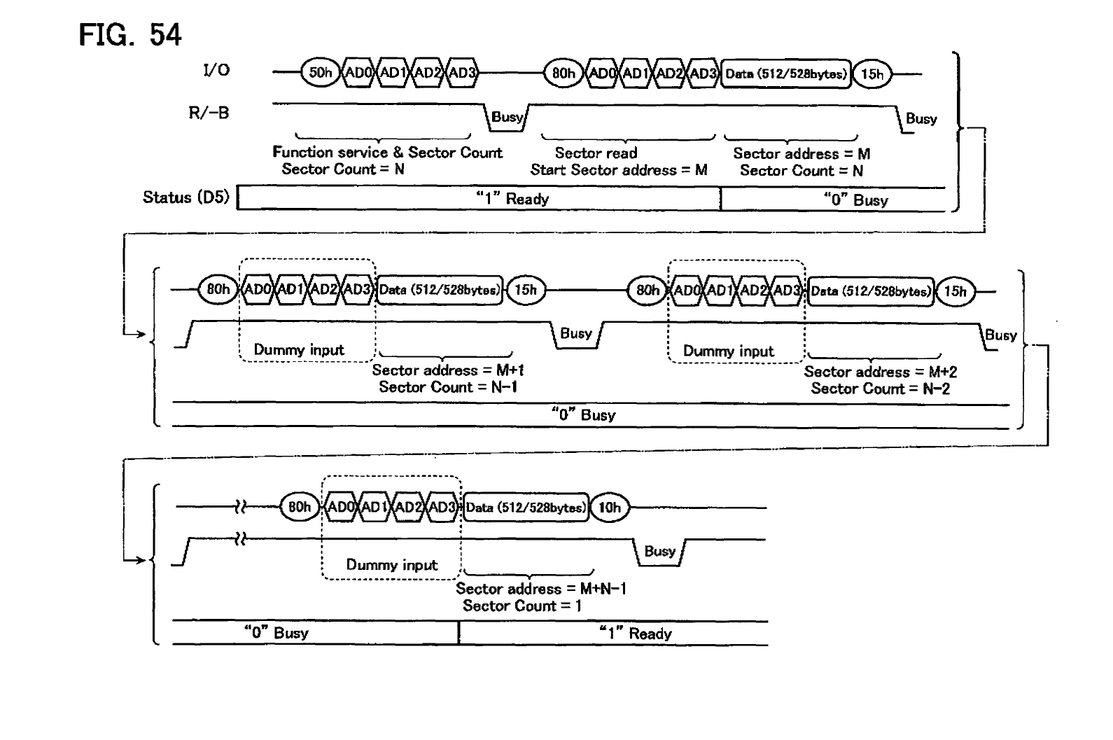

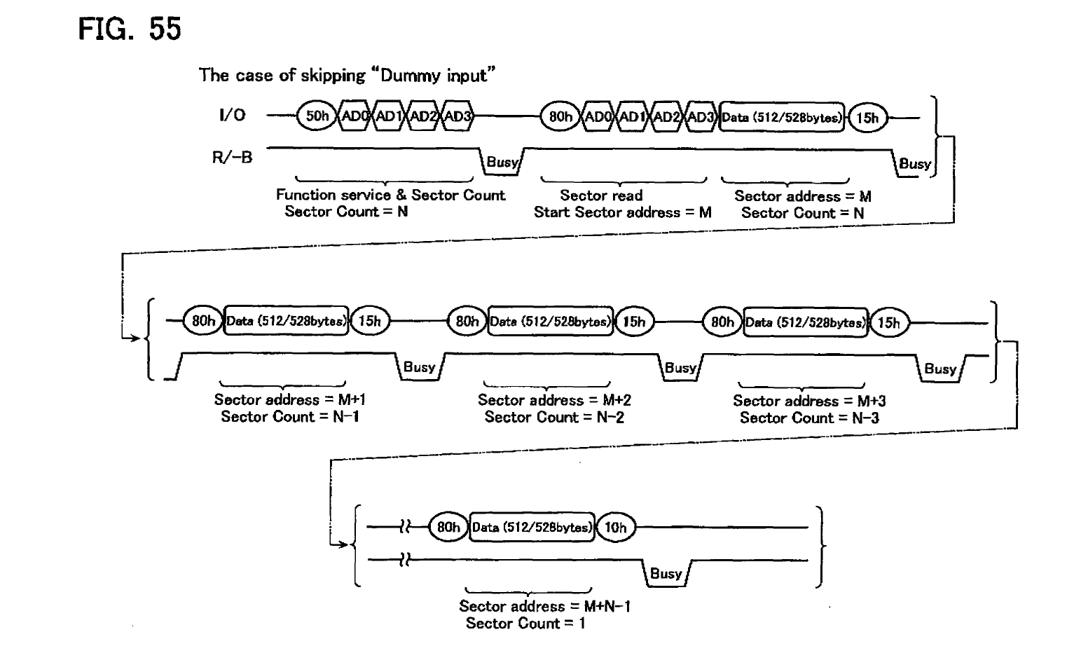

Similarly, FIGS. 54 and 55 illustrate a protocol of write sectors where sector counts are set. These drawings illustrate a busy state (D5=“0”) to be continuously exhibited from the first data read to arrival of the last data packet of read sectors, using a input/output pad D5 in “Status” read in addition to internal Ready/Busy.

Also in the case of write sectors, after the first sector address is input, a dummy sector address is input to continue the read operation.

FIG. 55 illustrates a case of skipping input of a dummy sector address after the first sector address is input. The host may use the “Status” read to detect whether the memory system is working on a series of operations of read sectors and write sectors, or has already completed the series of operations and can accept a new operation. In addition, when the host performs a multi-task operation and attempts an additional access to the memory system, a new task with a high priority occurs during execution of the application associated with read sectors. However, when the additional access attempt is made to the memory system, the memory system may be accessed by the host in correspondence with the new task, e.g., by issuing a termination command to complete a continued series of operations when D5 of the “Status” is “busy”.

What is claimed is:

1. A non-volatile memory system comprising:
a non-volatile memory; and
a memory controller controlling read and write of the non-volatile memory,
wherein access control of the non-volatile memory system is performed in accordance with a logical address, using an address translation table within the memory controller updated in association with data write and indicating a correlation between logical addresses provided by a host and physical addresses of the non-volatile memory, and wherein the non-volatile memory system is configured to be able to set a system configuration and function in relation to the host.

2. The non-volatile memory system according to claim 1, wherein
a first access mode and a second access mode are interchangeably set with one sector being as a minimum unit of data transfer for read/write, the first access mode having an access range in one command sequence fixed to one sector, and a second access mode having an access range of read/write and a transfer data size in the one-command sequence determined by input of a sector address and a sector count.

3. The non-volatile memory system according to claim 1 further comprising an ECC or CRC16 function checking any data transfer error, wherein
the ECC or CRC16 function can be selectively turned on and off.

4. The non-volatile memory system according to claim 1, wherein
a normal power mode and a high power mode are interchangeably set depending on a required operating speed performance.

5. The non-volatile memory system according to claim 1, wherein
the non-volatile memory system is a memory card.

6. The non-volatile memory system according to claim 1, wherein
the non-volatile memory has a memory cell array with a plurality of NAND cell units arranged therein, the plurality of NAND cell units having a plurality of electrically rewritable non-volatile memory cells connected in series, with one end of each of the NAND cell units being connected via a selection transistor to a bit line and the other end of each of the NAND cell units being connected via a selection transistor to a common source line.

7. The non-volatile memory system according to claim 6, wherein
the non-volatile memory is configured to be able to store multi-bit data for each of the non-volatile memory cells.

8. The non-volatile memory system according to claim 1, wherein the memory controller further comprises:
a first interface transferring data to and from the non-volatile memory;
a second interface transferring data to and from the host;
a data register temporarily storing data transferred by the first interface and the second interface; and
a processing unit controlling data transfer via the first interface and the second interface.

9. The non-volatile memory system according to claim 1, wherein
a first command is issued that allows the host to access based on a logical address, and response to the host is initiated on the condition of issuance of that first command.

10. The non-volatile memory system according to claim 9, wherein
a second command is issued that sets a system configuration prior to initiation of access to the host based on the first command.

11. The non-volatile memory system according to claim 10, wherein
the second command defines use/no use of an error correction function.

12. The non-volatile memory system according to claim 10, wherein
the second command defines a capacity of the non-volatile memory.
